(19) United States
(12) Patent Application Publication
(10) Pub. No.: US 2008/0062262 A1
(43) Pub. Date: Mar. 13, 2008

(54) Apparatus, method and system for screening receptacles and persons

(76) Inventors: Luc Perron, Charlesbourg (CA); Bertrand Couture, St-Nicolas (CA); Martin Lacasse, Levis (CA); Michel R. Bouchard, Sainte-Foy (CA); Eric Bergeron, Quebec (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 11/785,116

(22) Filed: Apr. 16, 2007

Related U.S. Application Data
(63) Continuation-in-part of application No. 11/407,217, filed on Apr. 20, 2006.
(63) Continuation-in-part of application No. 11/431,719, filed on May 11, 2006.
(63) Continuation-in-part of application No. 11/431,627, filed on May 11, 2006.
(63) Continuation-in-part of application No. PCT/CA05/00716, filed on May 11, 2005.
(60) Provisional application No. 60/865,340, filed on Nov. 10, 2006.

(51) Int. Cl. H04N 7/18

(52) U.S. Cl. 348/82; 348/E07.001

(57) ABSTRACT

An apparatus for performing a security screening operation on receptacles to detect presence of one or more prohibited objects in the receptacles. The apparatus may comprise an input for receiving image data conveying an image of contents of a receptacle, the image data being derived from a device that scans the receptacle with penetrating radiation. The apparatus may also comprise a processing unit for determining whether the image depicts at least one prohibited object. The apparatus may also comprise a graphical user interface (GUI) for displaying a representation of the contents of the receptacle on a basis of the image data. The GUI may also display a representation of the contents of each of one or more receptacles previously screened by the apparatus. When a detection of depiction of at least one prohibited object is made, the GUI may display information conveying a level of confidence in the detection. The GUI may also provide at least one control allowing a user to select whether or not the GUI is to highlight on the representation of the contents of the receptacle a location of each of at least one prohibited object deemed to be depicted in the image.

### CROSS-REFERENCE TO RELATED APPLICATIONS

This application claims the benefit under 35 USC 120 and is a continuation-in-part of: U.S. patent application Ser. No. 11/407,217 filed on Apr. 20, 2006; U.S. patent application Ser. No. 11/431,719 filed on May 11, 2006; U.S. patent application Ser. No. 11/431,627 filed on May 11, 2006; and International Application PCT/CA2005/000716 designating the U.S. and filed on May 11, 2005. This application also claims the benefit under 35 USC 119(e) of U.S. Provisional Patent Application No. 60/865,340 filed on Nov. 10, 2006. These related applications are hereby incorporated by reference herein.

### FIELD OF THE INVENTION

The present invention relates generally to security systems and, more particularly, to methods and systems for screening receptacles including, for example, luggage, mail parcels, or cargo containers to identify certain objects located therein, or for screening persons to identify objects located thereon.

### BACKGROUND

Security in airports, train stations, ports, office buildings, and other public or private venues is becoming increasingly important particularly in light of recent violent events.

Typically, security screening systems make use of devices generating penetrating radiation, such as x-ray devices, to scan receptacles such as, for example, individual pieces of luggage, mail parcels or cargo containers to generate an image conveying contents of the receptacle. The image is displayed on a screen and is examined by a human operator whose task it is to detect and possibly identify, on the basis of the image, potentially threatening objects located in the receptacle. In certain cases, some form of object recognition technology may be used to assist the human operator.

A deficiency with current systems is that they are mostly reliant on the human operator to detect and identify potentially threatening objects. However, the performance of the human operator greatly varies according to such factors as poor training and fatigue. As such, the detection and identification of threatening objects is highly susceptible to human error. Furthermore, it will be appreciated that failure to identify a threatening object, such as a weapon for example, may have serious consequences, such as property damage, injuries and fatalities.

Another deficiency with current systems is that the labour costs associated with such systems are significant since human operators must view the images.

Consequently, there is a need in the industry for providing a method and system for use in screening receptacles (such as luggage, mail parcels, or cargo containers) or persons to detect certain objects that alleviate at least in part deficiencies of prior systems and methods.

### SUMMARY OF THE INVENTION

As embodied and broadly described herein, the present invention provides an apparatus for screening a receptacle. The apparatus comprises an input for receiving an image signal associated with the receptacle, the image signal conveying an input image related to contents of the receptacle. The apparatus also comprises a processing unit in communication with the input. The processing unit is operative for: processing the image signal in combination with a plurality of data elements associated with a plurality of target objects in an attempt to detect a presence of at least one of the target objects in the receptacle; and generating a detection signal in response to detection of the presence of at least one of the target objects in the receptacle. The apparatus also comprises an output for releasing the detection signal.

The present invention also provides an apparatus for screening a person. The apparatus comprises an input for receiving an image signal associated with the person, the image signal conveying an input image related to objects carried by the person. The apparatus also comprises a processing unit in communication with the input. The processing unit is operative for: processing the image signal in combination with a plurality of data elements associated with a plurality of target objects in an attempt to detect a presence of at least one of the target objects on the person; and generating a detection signal in response to detection of the presence of at least one of the target objects on the person. The apparatus also comprises an output for releasing the detection signal.

The present invention also provides a computer readable storage medium storing a database suitable for use in detecting a presence of at least one target object in a receptacle. The database comprises a plurality of entries, each entry being associated to a respective target object whose presence in a receptacle it is desirable to detect during security screening. An entry for a given target object comprises a group of sub-entries, each sub-entry being associated to the given target object in a respective orientation. At least part of each sub-entry being suitable for being processed by a processing unit implementing a correlation operation to attempt to detect a representation of the given target object in an image of the receptacle.

The present invention also provides a computer readable storage medium storing a program element suitable for execution by a CPU, the program element implementing a graphical user interface for use in detecting a presence of one or more target objects in a receptacle. The graphical user interface is adapted for: displaying first information conveying an image associated with the receptacle, the image conveying contents of the receptacle; displaying second information conveying a presence of at least one target object in the receptacle, the second information being displayed simultaneously with the first information; and providing a control allowing a user to cause third information to be displayed, the third information conveying at least one characteristic associated to the at least one target object.

The present invention also provides an apparatus for screening a receptacle. The apparatus comprises an input for receiving an image signal associated with the receptacle, the image signal conveying an input image related to contents of the receptacle, the image signal having been produced by a device that is characterized by introducing distortion into the input image. The apparatus also comprises a processing unit in communication with the input. The processing unit is operative for: applying a distortion correction process to the image signal to remove at least part of the distortion from the input image, thereby to generate a corrected image signal conveying at least one corrected image related to the contents of the receptacle; processing the corrected image signal in combination with a plurality of data elements associated with a plurality of target objects in an attempt to detect a presence of at least one of the target objects in the receptacle; and generating a detection signal in response to detection of the presence of at least one of the target objects in the receptacle. The apparatus also comprises an output for releasing the detection signal.

The present invention also provides an apparatus for performing a security screening operation on receptacles to detect presence of one or more prohibited objects in the receptacles. The apparatus comprises an input for receiving image data conveying an image of contents of a currently screened receptacle, the image data being derived from a device that scans the currently screened receptacle with penetrating radiation. The apparatus also comprises a processing unit for determining whether the image depicts at least one prohibited object. The apparatus also comprises a storage component for storing history image data associated with images of contents of receptacles previously screened by the apparatus. The apparatus also comprises a graphical user interface for displaying a representation of the contents of the currently screened receptacle on a basis of the image data. The graphical user interface is adapted for displaying a representation of the contents of each of at least one of the receptacles previously screened by the apparatus on a basis of the history image data.

The present invention also provides a computer implemented graphical user interface for use in performing a security screening operation on receptacles to detect presence of one or more prohibited objects in the receptacles. The computer implemented graphical user interface comprises a component for displaying a representation of contents of a currently screened receptacle, the representation of contents of a currently screened receptacle being derived from image data conveying an image of the contents of the currently screened receptacle, the image data being derived from a device that scans the currently screened receptacle with penetrating radiation. The computer implemented graphical user interface is adapted for displaying a representation of contents of each of at least one of a plurality of previously screened receptacles, the representation of contents of each of at least one of a plurality of previously screened receptacles being derived from history image data associated with images of the contents of the previously screened receptacles.

The present invention also provides a method for performing a security screening operation on receptacles to detect presence of one or more prohibited objects in the receptacles. The method comprises receiving image data conveying an image of contents of a currently screened receptacle, the image data being derived from a device that scans the currently screened receptacle with penetrating radiation; processing the image data to determine whether the image depicts at least one prohibited object; storing history image data associated with images of contents of previously screened receptacles; displaying on a graphical user interface a representation of the contents of the currently screened receptacle on a basis of the image data; and displaying on the graphical user interface a representation of the contents of each of at least one of the previously screened receptacles on a basis of the history image data.

The present invention also provides an apparatus for performing a security screening operation on receptacles to detect presence of one or more prohibited objects in the receptacles. The apparatus comprises an input for receiving image data conveying an image of contents of a receptacle, the image data being derived from a device that scans the receptacle with penetrating radiation. The apparatus also comprises a processing unit for determining whether the image depicts at least one prohibited object. The apparatus also comprises a graphical user interface for: displaying a representation of the contents of the receptacle on a basis of the image data; and providing at least one control allowing a user to select whether or not the graphical user interface highlights on the representation of the contents of the receptacle a location of each of at least one prohibited object deemed to be depicted in the image.

The present invention also provides a computer implemented graphical user interface for use in performing a security screening operation on receptacles to detect presence of one or more prohibited objects in the receptacles. The computer implemented graphical user interface comprises a component for displaying a representation of contents of a receptacle, the representation of contents of a receptacle being derived from image data conveying an image of the contents of the receptacle, the image data being derived from a device that scans the receptacle with penetrating radiation. The computer implemented graphical user interface also comprises a component for providing at least one control allowing a user to select whether or not the computer implemented graphical user interface highlights on the representation of the contents of the receptacle a location of each of at least one prohibited object deemed to be depicted in the image.

The present invention also provides a method for performing a security screening operation on receptacles to detect presence of one or more prohibited objects in the receptacles. The method comprises receiving image data conveying an image of contents of a receptacle, the image data being derived from a device that scans the receptacle with penetrating radiation; processing the image data to determine whether the image depicts at least one prohibited object; displaying on a graphical user interface a representation of the contents of the receptacle on a basis of the image data; and providing on the graphical user interface at least one control allowing a user to select whether or not the graphical user interface highlights on the representation of the contents of the receptacle a location of each of at least one prohibited object deemed to be depicted in the image.

The present invention also provides an apparatus for performing a security screening operation on receptacles to detect presence of one or more prohibited objects in the receptacles. The apparatus comprises an input for receiving image data conveying an image of contents of a receptacle, the image data being derived from a device that scans the receptacle with penetrating radiation. The apparatus also comprises a processing unit for: processing the image data to detect depiction of one or more prohibited objects in the image; and responsive to detection that the image depicts at least one prohibited object, deriving a level of confidence in the detection. The apparatus also comprises a graphical user interface for displaying: a representation of the contents of the receptacle derived from the image data; and information conveying the level of confidence.

The present invention also provides a computer implemented graphical user interface for use in performing a security screening operation on receptacles to detect presence of one or more prohibited objects in the receptacles. The computer implemented graphical user interface comprises a component for displaying a representation of contents of a receptacle, the representation of contents of a receptacle being derived from image data conveying an image of the contents of the receptacle, the image data being derived from a device that scans the receptacle with penetrating radiation. The computer implemented graphical user interface also comprises a component for displaying information conveying a level of confidence in a detection that the image depicts at least one prohibited object, the detection being performed by a processing unit processing the image data.

The present invention also provides a method for performing a security screening operation on receptacles to detect presence of one or more prohibited objects in the receptacles. The method comprises receiving image data conveying an image of contents of a receptacle, the image data being derived from a device that scans the receptacle with penetrating radiation; processing the image data to detect depiction of one or more prohibited objects in the image; responsive to detection that the image depicts at least one prohibited object, deriving a level of confidence in the detection; displaying on a graphical user interface a representation of the contents of the receptacle derived from the image data; and displaying on the graphical user interface information conveying the level of confidence.

For the purpose of this specification, the expression “receptacle” is used to broadly describe an entity adapted for receiving objects therein such as, for example, a luggage item, a cargo container or a mail parcel.

For the purpose of this specification, the expression “luggage item” is used to broadly describe luggage, suitcases, handbags, backpacks, briefcases, boxes, parcels or any other similar type of item suitable for containing objects therein.

For the purpose of this specification, the expression “cargo container” is used to broadly describe an enclosure for storing cargo such as would be used, for example, in a ship, train, truck or any other suitable type of cargo container.

These and other aspects and features of the present invention will become apparent to those ordinarily skilled in the art upon review of the following description of specific embodiments of the invention in conjunction with the accompanying figures.

### BRIEF DESCRIPTION OF THE DRAWINGS

A detailed description of embodiments of the present invention is provided herein below, by way of example only, with reference to the accompanying drawings, in which:

FIG. 1 is a high-level block diagram of a system for screening a receptacle, in accordance with an embodiment of the present invention;

FIG. 2 is a block diagram of an output module of the system shown in FIG. 1, in accordance with an embodiment of the present invention;

FIG. 3 is a block diagram of an apparatus for processing images of the system shown in FIG. 1, in accordance with an embodiment of the present invention;

FIGS. 4A and 4B depict examples of visual outputs conveying a presence of at least one target object in the receptacle;

FIG. 5 is a flow diagram depicting a process for detecting a presence of at least one target object in the receptacle, in accordance with an embodiment of the present invention;

FIG. 6 shows three example images associated with a target object suitable for use in connection with the system shown in FIG. 1, each image depicting the target object in a different orientation;

FIG. 7 shows an example of data stored in a database of the system shown in FIG. 1, in accordance with an embodiment of the present invention;

FIG. 8 shows an example of a structure of the database, in accordance with an embodiment of the present invention;

FIG. 9 shows a system for generating data for entries of the database, in accordance with an embodiment of the present invention;

FIGS. 10A and 10B show examples of a positioning device of the system shown in FIG. 9, in accordance with an embodiment of the present invention;

FIG. 11 shows an example method for generating data for entries of the database, in accordance with an embodiment of the present invention;

FIG. 12 shows an apparatus for implementing a graphical user interface of the system shown in FIG. 1, in accordance with an embodiment of the present invention;

FIG. 13 shows a flow diagram depicting a process for displaying information associated to the receptacle, in accordance with an embodiment of the present invention;

FIGS. 14A and 14B depict examples of viewing windows of the graphical user interface displayed by the output module of FIG. 2, in accordance with an embodiment of the present invention;

FIG. 14C depicts an example of a viewing window of the graphical user interface displayed by the output module of FIG. 2, in accordance with another embodiment of the present invention;

FIG. 14D depicts an example of a control window of the graphical user interface displayed by displayed by the output module of FIG. 2 allowing a user to select screening options, in accordance with an embodiment of the present invention;

FIG. 15 diagrammatically illustrates the effect of distortion correction applied by the apparatus for processing images;

FIG. 16 diagrammatically illustrates an example of a template for use in a registration process in order to model distortion introduced by the image generation device;

FIG. 17A is a functional block diagram illustrating a correlator implemented by the apparatus for processing images of FIG. 3, in accordance with an embodiment of the present invention;

FIG. 17B is a functional block diagram illustrating a correlator implemented by the apparatus for processing images of FIG. 3, in accordance with another embodiment of the present invention;

FIG. 17C shows a peak observed in an output of the correlator of FIGS. 17A and 17B;

FIG. 18 depicts a Fourier transform, amplitude and phase, of the spatial domain image for number ‘2’;

FIG. 19 shows two example images associated with a person suitable for use in a system for screening a person in accordance with an embodiment of the present invention;

FIG. 20 is a block diagram of an apparatus suitable for implementing at least a portion of certain components of the system shown in FIG. 1, in accordance with an embodiment of the present invention; and

FIG. 21 is a functional block diagram of a client-server system suitable for use in screening a receptacle or person to detect therein or thereon a presence of one or more target objects, in accordance with an embodiment of the present invention.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION OF EMBODIMENTS

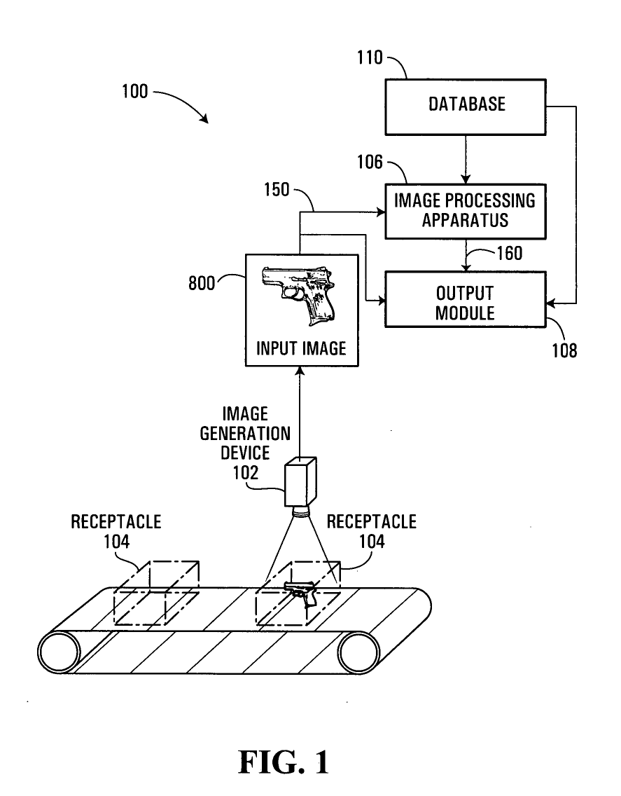

FIG. 1 shows a system 100 for screening a receptacle 104 in accordance with an embodiment of the present invention. The system 100 comprises an image generation device 102, an apparatus 106 in communication with the image generation device 102, and an output module 108.

The image generation device 102 generates an image signal 150 associated with the receptacle 104. The image signal 150 conveys an input image 800 related to contents of the receptacle 104.

The apparatus 106 receives the image signal 150 and processes the image signal 150 in combination with a plurality of data elements associated with a plurality of target objects in an attempt to detect a presence of one or more target objects in the receptacle 104. In this embodiment, the data elements associated with the plurality of target objects are stored in a database 110.

In response to detection of the presence of one or more target objects in the receptacle 104, the apparatus 106 generates a detection signal 160 which conveys the presence of one or more target objects in the receptacle 104. Examples of the manner in which the detection signal 160 can be generated are described later on. The output module 108 conveys information derived at least in part on the basis of the detection signal 160 to a user of the system 100.

Advantageously, the system 100 provides assistance to human security personnel using the system 100 in detecting certain target objects and decreases the susceptibility of the screening process to human error.

Image Generation Device 102

In this embodiment, the image generation device 102 uses penetrating radiation or emitted radiation to generate the image signal 150. Examples of such devices include, without being limited to, x-ray, gamma ray, computed tomography (CT scans), thermal imaging, and millimeter wave devices. Such devices are known in the art and as such will not be described further here. In a non-limiting example of implementation, the image generation device 102 comprises a conventional x-ray machine and the input image 800 related to the contents of the receptacle 104 is an x-ray image of the receptacle 104 generated by the x-ray machine.

The input image 800 related to the contents of the receptacle 104, which is conveyed by the image signal 150, may be a two-dimensional (2-D) image or a three-dimensional (3-D) image, and may be in any suitable format such as, without limitation, VGA, SVGA, XGA, JPEG, GIF, TIFF, and bitmap amongst others. The input image 800 related to the contents of the receptacle 104 may be in a format that can be displayed on a display screen.

In some embodiments (e.g., where the receptacle 104 is large, as is the case with a cargo container), the image generation device 102 may be configured to scan the receptacle 104 along various axes to generate an image signal conveying multiple input images related to the contents of the receptacle 104. Scanning methods for large objects are known in the art and as such will not be described further here. Each of the multiple images is then processed in accordance with the method described herein below to detect the presence of one or more target objects in the receptacle 104.

In some cases, the image generation device 102 may introduce distortion into the input image 800. More specifically, different objects appearing in the input image 800 may be distorted to different degrees, depending on a given object's position within the input image 800 and on the given object's height within the receptacle 104 (which sets the distance between the given object and the image generation device 102).

Database 110

In this embodiment, the database 110 includes a plurality of entries associated with respective target objects that the system 100 is designed to detect. A non-limiting example of a target object is a weapon. The entry in the database 110 that is associated with a particular target object includes data associated with the particular target object.

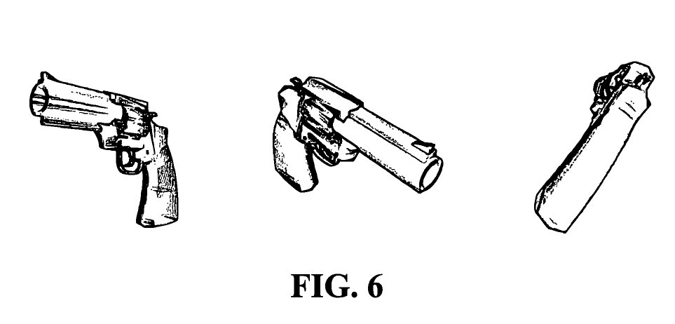

The data associated with the particular target object may comprise one or more images of the particular target object. The format of the one or more images of the particular target object will depend upon one or more image processing algorithms implemented by the apparatus 106, which is described later. Where plural images of the particular target object are provided, these images may depict the particular target object in various orientations. FIG. 6 depicts an example of arbitrary 3D orientations of a particular target object.

The data associated with the particular target object may also or alternatively comprise the Fourier transform of one or more images of the particular target object. The data associated with the particular target object may also comprise characteristics of the particular target object. Such characteristics may include, without being limited to, the name of the particular target object, its associated threat level, the recommended handling procedure when the particular target object is detected, and any other suitable information. The data associated with the particular target object may also comprise a target object identifier.

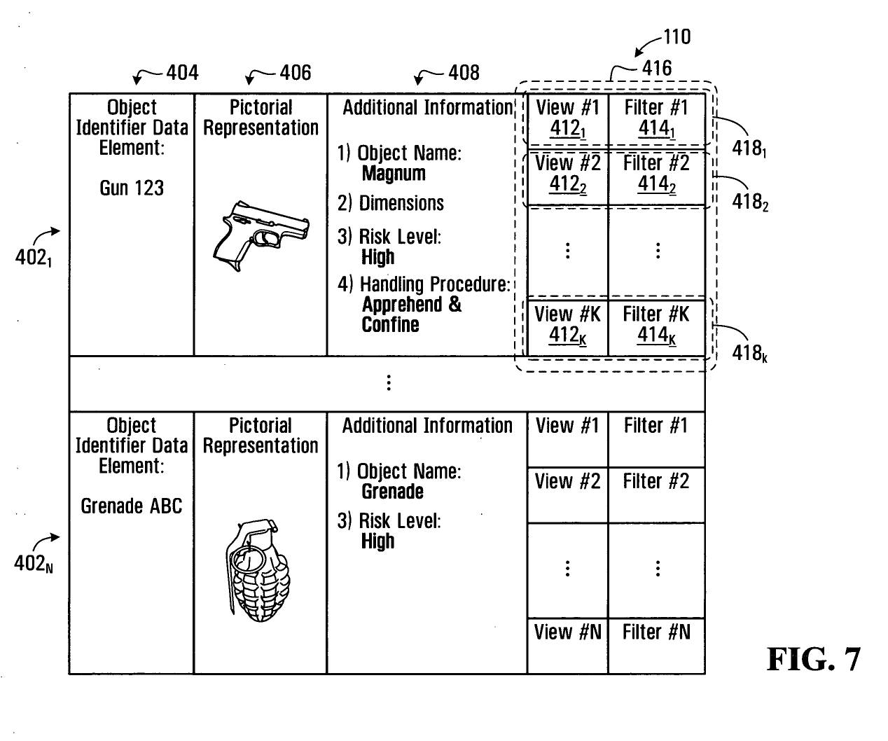

FIG. 7 is illustrates an example of data stored in the database 110 (e.g., on a computer readable medium) in accordance with an embodiment of the present invention.

In this embodiment, the database 110 comprises a plurality of entries 402₁-402_{N}, each entry 402ₙ (1≦n≦N) being associated to a respective target object whose presence in a receptacle it is desirable to detect.

The types of target objects having entries in the database 110 will depend upon the application in which the database 110 is being used and on the target objects the system 100 is designed to detect.

For example, if the database 110 is used in the context of luggage screening in an airport, it will be desirable to detect certain types of target objects that may present a security risk. As another example, if the database 110 is used in the context of cargo container screening at a port, it will be desirable to detect other types of target objects. For instance, these other types of objects may include contraband items, items omitted from a manifest, or simply items which are present in the manifest associated to the cargo container. In the example shown in FIG. 7, the database 110 includes, amongst others, an entry 402₁ associated to a gun and an entry 402_{N} associated to a grenade. When the database 110 is used in a security application, at least some of the entries 402₁-402_{N} in the database 110 will be associated to prohibited objects such as weapons or other threat objects.

The entry 402ₙ associated with a given target object comprises data associated with the given target object.

More specifically, in this embodiment, the entry 402ₙ associated with a given target object comprises a group 416 of sub-entries 418₁-418_{K}. Each sub-entry 418ₖ (1≦k≦K) is associated to the given target object in a respective orientation. For instance, in the example shown in FIG. 7, sub-entry 418₁ is associated to a first orientation of the given target object (in this case, a gun identified as “Gun123”); sub-entry 418₂ is associated to a second orientation of the given target object; and sub-entry 418_{K} is associated to a K^{th} orientation of the given target object. Each orientation of the given target object can correspond to an image of the given target object taken when the given target object is in a different position.

The number of sub-entries 418₁-418_{K} in a given entry 402ₙ may depend on a number of factors including, but not limited to, the type of application in which the database 110 is intended to be used, the given target object associated to the given entry 402ₙ, and the desired speed and accuracy of the overall screening system in which the database 110 is intended to be used. More specifically, certain objects have shapes that, due to their symmetric properties, do not require a large number of orientations in order to be adequately represented. Take for example images of a spherical object which, irrespective of the spherical object's orientation, will look substantially identical to one another and therefore the group of sub-entries 416 may include a single sub-entry for such an object. However, an object having a more complex shape, such as a gun, would require multiple sub-entries in order to represent the different appearances of the object when in different orientations. The greater the number of sub-entries in the group of sub-entries 416 for a given target object, the more precise the attempt to detect a representation of the given target object in an image of a receptacle can be. However, this also means that a larger number of sub-entries must be processed which increases the time required to complete the processing. Conversely, the smaller the number of sub-entries in the group of sub-entries 416 for a given target object, the faster the speed of the processing can be performed but the less precise the detection of that target object in an image of a receptacle. As such, the number of sub-entries in a given entry 402ₙ is a trade-off between the desired speed and accuracy and may depend on the target object itself as well. In certain embodiments, the group of sub-entries 416 may include four or more sub-entries 418₁-418_{K}.

In this example, each sub-entry 418ₖ in the entry 402ₙ associated with a given target object comprises data suitable for being processed by a processing unit implementing a correlation operation to attempt to detect a representation of the given target object in an image of the receptacle 104.

More particularly, in this embodiment, each sub-entry 418ₖ in the entry 402ₙ associated with a given target object comprises a data element 414ₖ (1≦k≦K) regarding a filter (hereinafter referred to as a “filter data element”). The filter can also be referred to as a template, in which case “template data element” may sometimes be used herein. In one example of implementation, each filter data element is derived based at least in part on an image of the given target object in a certain orientation. For instance, the filter data element 414ₖ may be indicative of a Fourier transform (or Fourier transform complex conjugate) of the image of the given target object in the certain implementation. Thus, in such an example, each filter data element is indicative of the Fourier transform (or Fourier transform complex conjugate) of the image of the given target object in the certain orientation. The Fourier transform may be stored in mathematical form or as an image of the Fourier transform of the image of the given target object in the certain orientation. In another example of implementation, each filter data element is derived based at least in part on a function of the Fourier transform of the image of the given target object in the certain orientation. In yet another example of implementation, each filter data element is derived based at least in part on a function of the Fourier transform of a composite image, the composite image including at least the image of the given target object in the certain orientation. Examples of the manner in which a given filter data element may be derived will be described later on.

In this embodiment, each sub-entry 418ₖ in the entry 402ₙ associated with the given target object also comprises a data element 412ₖ (1≦k≦K) regarding an image of the given target object in the certain orientation corresponding to that sub-entry (hereinafter referred to as an “image data element”). The image can be that on which is based the filter corresponding to the data element 414ₖ.

It will be appreciated that, in some embodiments, the image data element 412ₖ of each of one or more of the sub-entries 418₁-418_{K} may be omitted. Similarly, in other embodiments, the filter data element 414ₖ of each of one or more of the sub-entries 418₁-418_{K} may be omitted.

The entry 402ₙ associated with a given target object may also comprise data 406 suitable for being processed by a computing apparatus to derive a pictorial representation of the given target object. Any suitable format for storing the data 406 may be used. Examples of such formats include, without being limited to, bitmap, jpeg, gif, or any other suitable format in which a pictorial representation of an object may be stored.

The entry 402ₙ associated with a given target object may also comprise additional information 408 associated with the given target object. The additional information 408 will depend upon the type of given target object as well as the specific application in which the database 110 is intended to be used. Thus, the additional information 408 can vary from one implementation to another. Examples of the additional information 408 include, without being limited to:
a risk level associated with the given target object;
a handling procedure associated with the given target object;
a dimension associated with the given target object;
a weight information element associated with the given target object;
a description of the given target object;
a monetary value associated with the given target object or an information element allowing a monetary value associated with the given target object to be derived; and
any other type of information associated with the given target object that may be useful in the application in which the database 110 is intended to be used.

In one example, the risk level associated to the given target object (first example above) may convey the relative risk level of the given target object compared to other target objects in the database 110. For example, a gun would be given a relatively high risk level while a metallic nail file would be given a relatively low risk level, and a pocket knife would be given a risk level between that of the nail file and the gun.

In another example, information regarding the monetary value associated with the given target object may be an actual monetary value such as the actual value of the given target object or the value of the given target object for customs purposes, or information allowing such a monetary value to be computed (e.g., a weight or size associated to the given target object). Such a monetary value is particularly useful in applications where the value of the content of a receptacle is of importance such as, for example, mail parcels delivery and customs applications.

The entry 402ₙ associated with a given target object may also comprise an identifier 404. The identifier 404 allows each entry 402ₙ in the database 110 to be uniquely identified and accessed for processing.

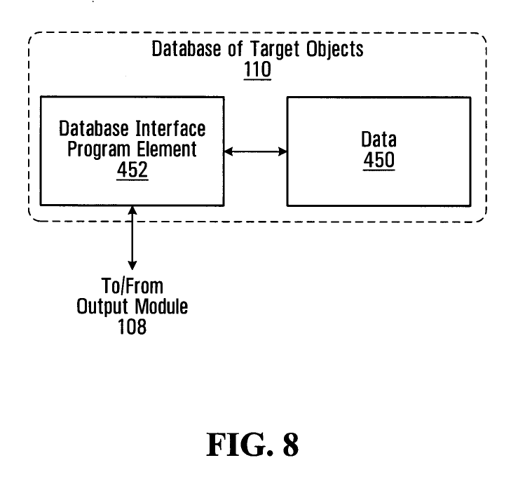

As mentioned previously, the database 110 may be stored on a computer readable storage medium that is accessible by a processing unit. Optionally, the database 110 may be provided with a program element implementing an interface adapted to interact with an external entity. Such an embodiment is depicted in FIG. 8. In that embodiment, the database 110 comprises a program element 452 implementing a database interface and a data store 450 for storing the data of the database 110. The program element 452, when executed by a processor, is responsive to a query signal requesting information associated to a given target object for locating in the data store 450 an entry corresponding to the given target object. The query signal may take on various suitable forms and, as such, will not be described further here. Once the entry is located, the program element 452 extracts information from the entry corresponding to the given target object on the basis of the query signal. The program element 452 then proceeds to cause a signal conveying the extracted information to be transmitted to an entity external to the database 110. The external entity may be, for example, the output module 108 (FIG. 1).

Although the database 110 has been described with reference to FIG. 7 as including certain types of information, it will be appreciated that the specific design and content of the database 110 may vary from one embodiment to another, and may depend upon the application in which the database 110 is intended to be used.

Also, although the database 110 is shown in FIG. 1 as being a component separate from the apparatus 106, it will be appreciated that, in some embodiments, the database 110 may be part of the apparatus 106. It will also be appreciated that, in certain embodiments, the database 110 may be shared between multiple apparatuses such as the apparatus 106.

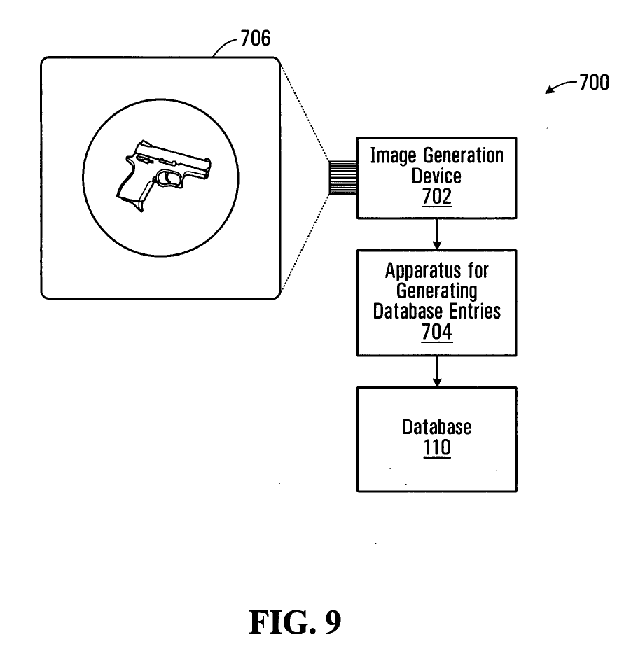

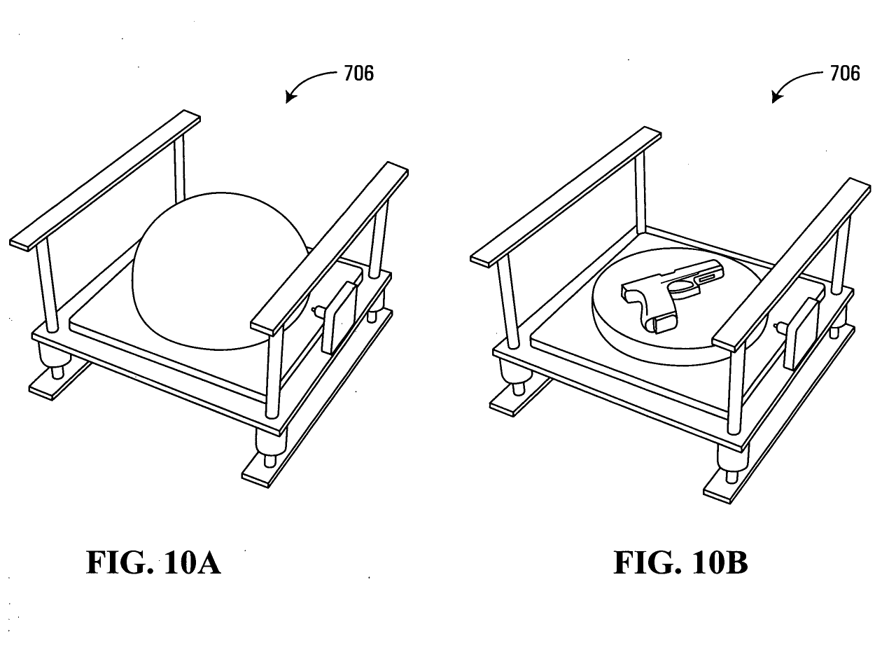

Referring now to FIG. 9, there is shown an embodiment of a system 700 for generating data to be stored as part of entries in the database 110. In this embodiment, the system 700 comprises an image generation device 702, an apparatus 704 for generating database entries, and a positioning device 706.

The image generation device 702 is adapted for generating image signals associated with a given target object whose presence in a receptacle it is desirable to detect. The image generation device 702 may be similar to the image generation device 102 described above.

The apparatus 704 is in communication with the image generation device 702 and with a memory unit storing the database 110. The apparatus 704 receives at an input the image signals associated with the given target object from the image generation device 702.

The apparatus 704 comprises a processing unit in communication with the input. In this embodiment, the processing unit of the apparatus 704 processes the image signals associated with the given target object to generate respective filter data elements (such as the filter data elements 414₁-414_{K} described above). The generated filter data elements are suitable for being processed by a device implementing a correlation operation to attempt to detect a representation of the given target object in an image of a receptacle. For example, the filter data elements may be indicative of the Fourier transform (or Fourier transform complex conjugate) of an image of the given target object. The filter data elements may also be referred to as templates. Examples of other types of filters that may be generated by the apparatus 704 and the manner in which they may be generated will be described later on. The filter data elements are then stored in the database 110 in connection with an entry associated with the given target object (such as one of the entries 402₁-402_{N} described above).

In this embodiment, the system 700 comprises the positioning device 706 for positioning a given target object in two or more distinct orientations such as to allow the image generation device 702 to generate an image signal associated with the given target object in each of the two or more distinct orientations. FIGS. 10A and 10B illustrate a non-limiting example of implementation of the positioning device 706. As shown in FIG. 10A, the positioning device 706 comprises a hollow spherical housing on which indices identifying various angles are marked to indicate the position of the housing relative to a reference frame. The spherical housing is held in place by a receiving member also including markings to indicate position. The spherical housing and the receiving member are preferably made of a material that is substantially transparent to the image generation device 702. For example, in embodiments where the image generation device 702 is an x-ray machine, the spherical housing and the receiving member are made of a material that appears as being substantially transparent to x-rays. The spherical housing and the receiving member may be made, for instance, of a Styrofoam-type material. The spherical housing includes a portion that can be removed in order to be able to position an object within the housing. FIG. 10B shows the positioning device 706 with the removable portion displaced. Inside the hollow spherical housing is provided a transparent supporting structure adapted for holding an object in a suspended manner within the hollow spherical housing. The supporting structure is such that when the removable portion of the spherical housing is repositioned on the other part of the spherical housing, the housing can be rotated in various orientations, thereby imparting those various orientations to the object positioned within the hollow housing. The supporting structure is also made of a material that is transparent to the image generation device 702.

The apparatus 704 may include a second input (not shown) for receiving supplemental information associated with a given target object and for storing that supplemental information in the database 110 in connection with an entry associated with the given target object (such as one of the entries 402₁-402_{N} described above). The second input may be implemented as a data connection to a memory device or as an input device such as a keyboard, mouse, pointer, voice recognition device, or any other suitable type of input device. Examples of supplemental information that may be provided include, but are not limited to:
images conveying pictorial information associated to the given target object;
a risk level associated with the given target object;
a handling procedure associated with the given target object;
a dimension associated with the given target object;
a weight information element associated with the given target object;
a description of the given target object;
a monetary value associated with the given target object or an information element allowing a monetary value associated with the given target object to be derived; and
any other type of information associated with the given target object that may be useful in the application in which the database 110 is intended to be used.

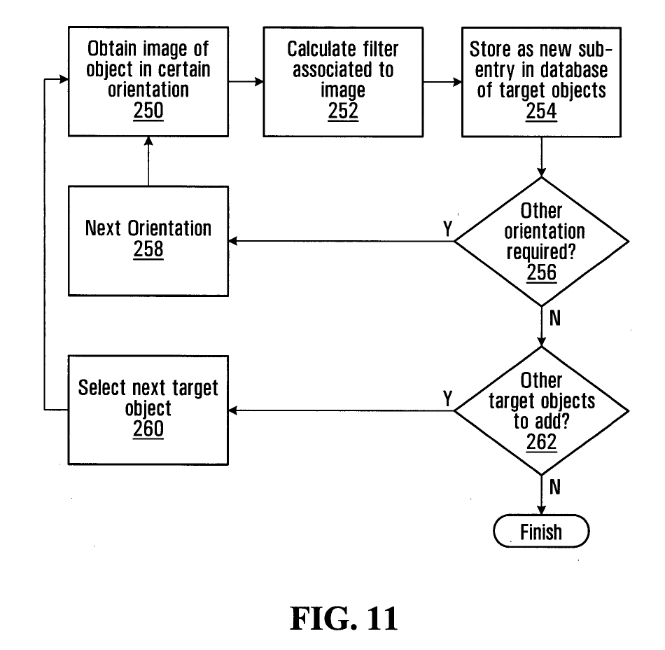

With reference to FIGS. 9 and 11, an example of a method for generating data for an entry in the database 110 will now be described.

At step 250, an image of a given target object in a given orientation is obtained. The image may have been pre-stored on a computer readable medium and in that case obtaining the image of the given target object in the given orientation involves extracting data corresponding to the image of the given target object in the given orientation from that computer readable medium. Alternatively, at step 250, a given target object is positioned in a given orientation on the positioning device 706 in the viewing field of the image generation device 702 and an image of the given target object in the given orientation is then obtained by the image generation device 702. At step 252, the image of the given target object in the given orientation obtained at step 250 is processed by the apparatus 704 to generate a corresponding filter data element. As previously indicated, the generated filter data element is suitable for being processed by a processing unit implementing a correlation operation to attempt to detect a representation of the given target object in an image of a receptacle.

At step 254, a new sub-entry associated to the given target object (such as one of the sub-entries 418₁-418_{K} described above) is created in the database 110 and the filter data element generated at step 252 is stored as part of that new sub-entry. Optionally, the image of the given target object in the given orientation obtained at step 250 may also be stored as part of the new sub-entry (e.g., as one of the image data elements 412₁-412_{K} described above).

At step 256, it is determined whether another image of the given target object in a different orientation is required. The requirements may be generated automatically (e.g., there is a pre-determined number of orientations required for the given target object or for all target objects) or may be provided by a user using an input device.

If another image of the given target object in a different orientation is required, step 256 is answered in the affirmative and the method proceeds to step 258. At step 258, the next orientation is selected, leading to step 250 where an image of the given target object in the next orientation is obtained. The image of given target object in the next orientation may have been pre-stored on a computer readable medium and in that case selecting the next orientation at step 258 involves locating the corresponding data on the computer readable medium. Alternatively, at step 258 the next orientation of the given target object is determined.

If no other image of the given target object in a different orientation is required, step 256 is answered in the negative and the method proceeds to step 262. At step 262, it is determined whether there remains any other target object(s) to be processed. If there remains one or more other target objects to be processed, step 262 is answered in the affirmative and the method proceeds to step 260 where the next target object is selected and then to step 250 where an image of the next target object in a given orientation is obtained. If at step 262 there are no other target objects that remain to be processed, step 262 is answered in the negative and the process is completed. In some cases, step 262 may be preceded by an additional step (not shown) in which the aforementioned supplemental information may be stored in the database 110 in association with the entry corresponding to the given target object.

As indicated above with reference to step 250, the images of the target objects may have been obtained and pre-stored on a computer readable medium prior to the generation of data for the entries of the database 110. In such a case, step 250 may be preceded by another step (not shown). This other step would include obtaining a plurality of images of the given target object by sequentially positioning the given target object in different orientations and obtaining an image of the given target object in each of the different orientations using the image generation device 702. These images would then be stored on a computer readable storage medium.

Once the database 110 has been created by a process such as the one described above, it can be incorporated into a system such as the system 100 shown in FIG. 1 and used to detect a presence of one or more target objects in a receptacle. The database 110 may be provided as part of such a system or may be provided as a separate component to the system or as an update to an already existing database of target objects.

Therefore, the example method described in connection with FIG. 11 may further include a step (not shown) of providing the contents of the database 110 to a facility including a security screening station for use in detecting in a receptacle a presence of one or more target objects from the database 110. The facility may be located in a variety of places including, but not limited to, an airport, a mail sorting station, a border crossing, a train station and a building. Alternatively, the example method described above in connection with FIG. 11 may further include a step (not shown) of providing the contents of the database 110 to a customs station for use in detecting in a receptacle a presence of one or more target objects from the database 110.

As described above, the apparatus 704 is adapted for processing an image of a given target object in a given orientation to generate a corresponding filter data element.

Optionally, image processing and enhancement can be performed on the image of the given target object to obtain better matching performance depending on the environment and application.

Many methods for generating filters are known and a few such methods will be described later on.

For example, in one case, the generation of the reference template or filter data element may be performed in a few steps. First, the background is removed from the image of the given target object. In other words, the image is extracted from the background and the background is replaced by a black background. The resulting image is then processed through a Fourier transform function. The result of this transform is a complex image. The resulting Fourier transform (or its complex conjugate) may then be used as the filter data element corresponding to the image of the given target object.

Alternatively, the filter data element may be derived on the basis of a function of a Fourier transform of the image of the given target object in the given orientation. For example, a phase only filter (POF) may be generated by the apparatus 704. A phase only filter (POF) for example contains the complex conjugate of the phase information (between zero and 2π) which is mapped to a 0 to 255 range values. These 256 values correspond in fact to the 256 levels of gray of an image. The reader is invited to refer to the following document, which is hereby incorporated by reference herein, for additional information regarding phase only filters (POF): “Phase-Only Matched Filtering”, Joseph L. Horner and Peter D. Gianino, Appl. Opt. Vol. 23 no. 6, 15 Mar. 1994, pp. 812-816.

As another possible alternative, the filter may be derived on the basis of a function of a Fourier transform of a composite image, the composite image including a component derived from the given target object in the given orientation. For example, in order to reduce the amount of data needed to represent the whole range of 3D orientations that a single target object can take, the apparatus 704 may be operative for generating a MACE (Minimum Average Correlation Energy) filter for a given target object. Typically, the MACE filter combines several different 2D projections of a given object and encodes them in a single MACE filter instead of having one 2D projection per filter. One of the benefits of using MACE filters is that the resulting database 110 would take less space since it would include fewer items. Also, since the number of correlation operations needed to identify a single target object would be reduced, the total processing time to determine whether a given object is present would also be reduced. The reader is invited to refer to the following document, which is hereby incorporated by reference herein, for additional information regarding MACE filters: Mahalanobis, A., B. V. K. Vijaya Kumar, and D. Casasent (1987); Minimum average correlation energy filters, Appl. Opt. 26 no. 17, 3633-3640.

It will readily be appreciated that various other types of templates or filters can be generated.

Output Module 108

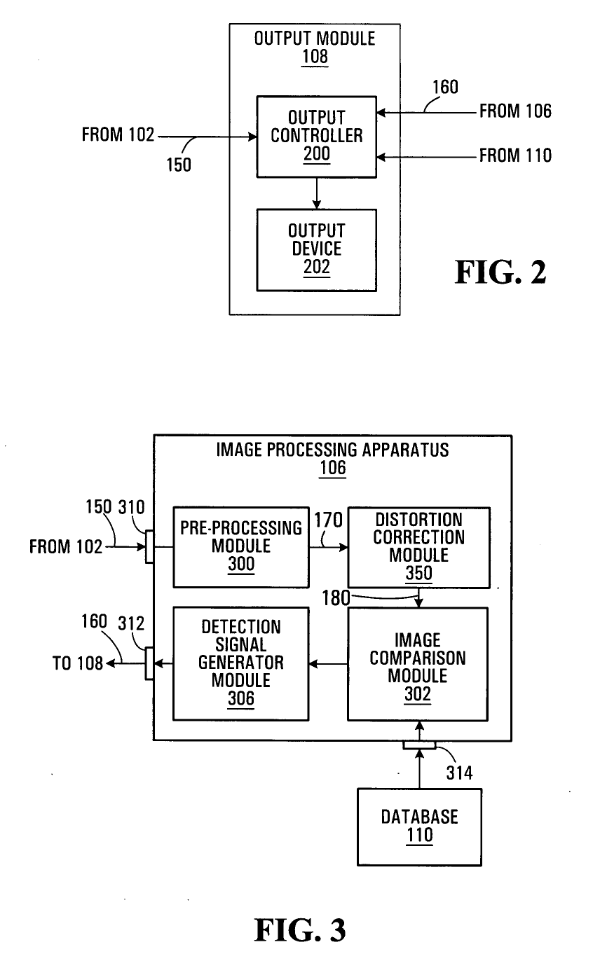

In this embodiment, the output module 108 conveys to a user of the system 100 information derived at least in part on the basis of the detection signal 160. FIG. 2 shows an example of implementation of the output module 108. In this example, the output module 108 comprises an output controller 200 and an output device 202.

The output controller 200 receives from the apparatus 106 the detection signal 160 conveying the presence of one or more target objects (hereinafter referred to as “detected target objects”) in the receptacle 104. In one embodiment, the detection signal 160 conveys information regarding the position and/or orientation of the one or more target detected target objects within the receptacle 104. The detection signal 160 may also convey one or more target object identifier data elements (such as the identifier data elements 404 of the entries 402₁-402_{N} in the database 110 described above), which permit identification of the one or more detected target objects.

The output controller 200 then releases a signal for causing the output device 202 to convey information related to the one or more detected target objects to a user of the system 100.

In one embodiment, the output controller 200 may be adapted to cause a display of the output device 202 to convey information related to the one or more detected target objects. For example, the output controller 200 may generate image data conveying the location of the one or more detected target objects within the receptacle 104. The output controller 200 may also extract characteristics of the one or more detected target objects from the database 110 on the basis of the target object identifier data element and generate image data conveying the characteristics of the one or more detected target objects. As another example, the output controller 200 may generate image data conveying the location of the one or more detected target objects within the receptacle 104 in combination with the input image 800 generated by the image generation device 102.

In another embodiment, the output controller 200 may be adapted to cause an audio unit of the output device 202 to convey information related to the one or more detected target objects. For example, the output controller 200 may generate audio data conveying the presence of the one or more detected target objects, the location of the one or more detected target objects within the receptacle 104, and the characteristics of the one or more detected target objects.

The output device 202 may be any device suitable for conveying information to a user of the system 100 regarding the presence of one or more target objects in the receptacle 104. The information may be conveyed in visual format, audio format, or as a combination of visual and audio formats.

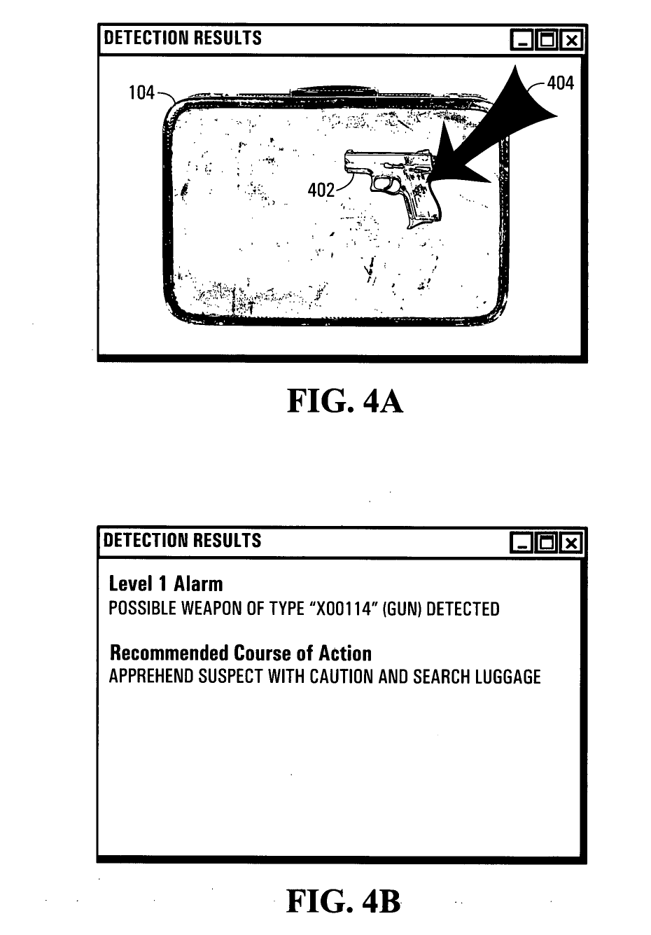

For example, the output device 202 may include a display adapted for displaying in visual format information related to the presence of the one or more detected target objects. FIGS. 4A and 4B show examples of information in visual format related to the presence of the one or more detected target objects. More specifically, in FIG. 4A, the input image generated by the image generation device 102 is displayed along with a visual indicator (e.g., an arrow 404) identifying the location of a specific detected target object (e.g., a gun 402) detected by the apparatus 106. In FIG. 4B, a text message is provided describing a specific detected target object. It will be appreciated that the output device 202 may provide other information that that shown in the examples of FIGS. 4A and 4B, which are provided for illustrative purposes only.

In another example, the output device 202 may include a printer adapted for displaying in printed format information related to the presence of the one or more detected target objects. In yet another example, the output device 202 may include an audio unit adapted for releasing an audio signal conveying information related to the presence of the one or more detected target objects. In yet another example, the output device 202 may include a set of visual elements, such as lights or other suitable visual elements, adapted for conveying in visual format information related to the presence of the one or more detected target objects.

It will be appreciated that other suitable types of output devices may be used in other embodiments.

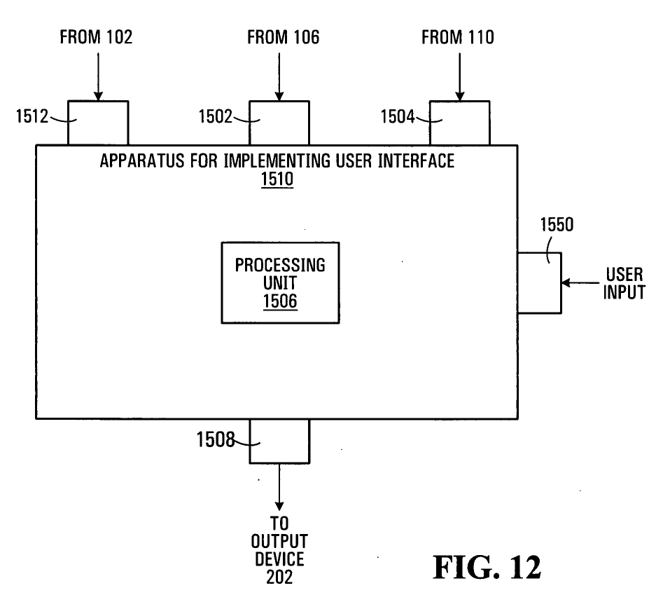

In one embodiment, which will now be described with reference to FIG. 12, the output controller 200 comprises an apparatus 1510 for implementing a graphical user interface. In this embodiment, the output controller 200 is adapted for communicating with a display of the output device 202 for causing display thereon of the graphical user interface.

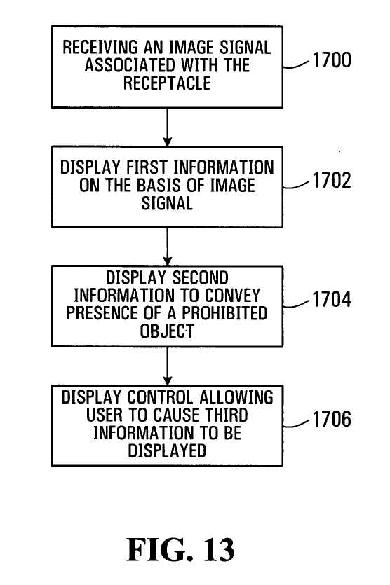

An example of a method implemented by the apparatus 1510 is illustrated in FIG. 13. In this example, at step 1700, an image signal associated with a receptacle is received, the image signal conveying an input image related to contents of the receptacle (e.g., the image signal 150 associated with the receptacle 104 and conveying the input image 800 related to contents of the receptacle 104). At step 1702, first information conveying the input image is displayed based on the image signal. At step 1704, second information conveying a presence of at least one target object in the receptacle is displayed. The second information may be displayed simultaneously with the first information. The second information is derived from a detection signal received from the apparatus 106 and conveying the presence of at least one target object in the receptacle (e.g., the detection signal 160 conveying the presence of one or more target objects in the receptacle 104). Optionally, at step 1706, a control is provided for allowing a user to cause display of third information conveying at least one characteristic associated to each detected target object.

In this case, the apparatus 1510 comprises a first input 1512, a second input 1502, a third input 1504, a user input 1550, a processing unit 1506, and an output 1508.

The first input 1512 is adapted for receiving an image signal associated with a receptacle, the image signal conveying an input image related to contents of the receptacle (e.g., the image signal 150 associated with the receptacle 104 and conveying the input image 800 related to contents of the receptacle 104).

The second input 1502 is adapted for receiving a detection signal conveying a presence of at least one target object in the receptacle (e.g., the detection signal 160 conveying the presence of one or more target objects in the receptacle 104). Various information can be received at the second input 1502 depending on the specific implementation of the apparatus 106. Examples of information that may be received include information about a position of each of the at least one detected target object within the receptacle, information about a level of confidence of the detection, and information allowing identification of each of the at least one detected target object.

The third input 1504 is adapted for receiving from the database 110 additional information regarding the one or more target objects detected in the receptacle. Various information can be received at the third input 1504 depending on contents of the database 110. Examples of information that may be received include images depicting each of the one or more detected target objects and/or characteristics of the target object. Such characteristics may include, without being limited to, the name of the detected target object, dimensions of the detected target object, its associated threat level, the recommended handling procedure when such a target object is detected, and any other suitable information.

The user input 1550 is adapted for receiving signals from a user input device, the signals conveying commands for controlling the information displayed by the graphical user interface or for modifying (e.g., annotating) the displayed information. Any suitable user input device for providing user commands may be used such as, for example, a mouse, keyboard, pointing device, speech recognition unit, touch sensitive screen, etc.

The processing unit 1506 is in communication with the first input 1512, the second input 1502, the third input 1504, and the user input 1550 and implements the graphical user interface.

The output 1508 is adapted for releasing a signal for causing the output device 202 to display the graphical user interface implemented by the processing unit 1506.

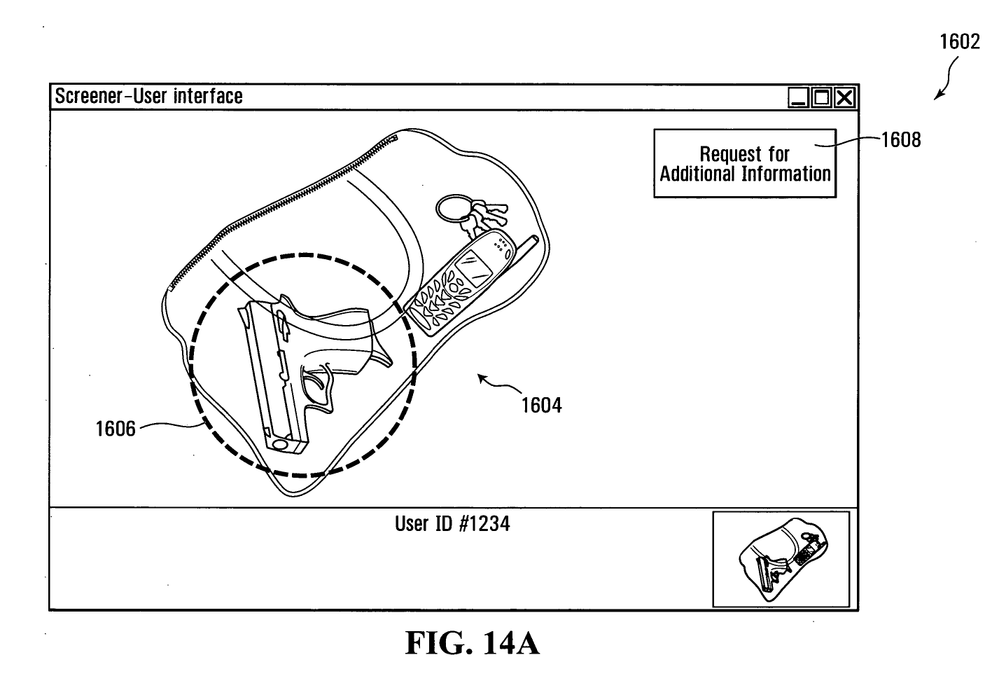

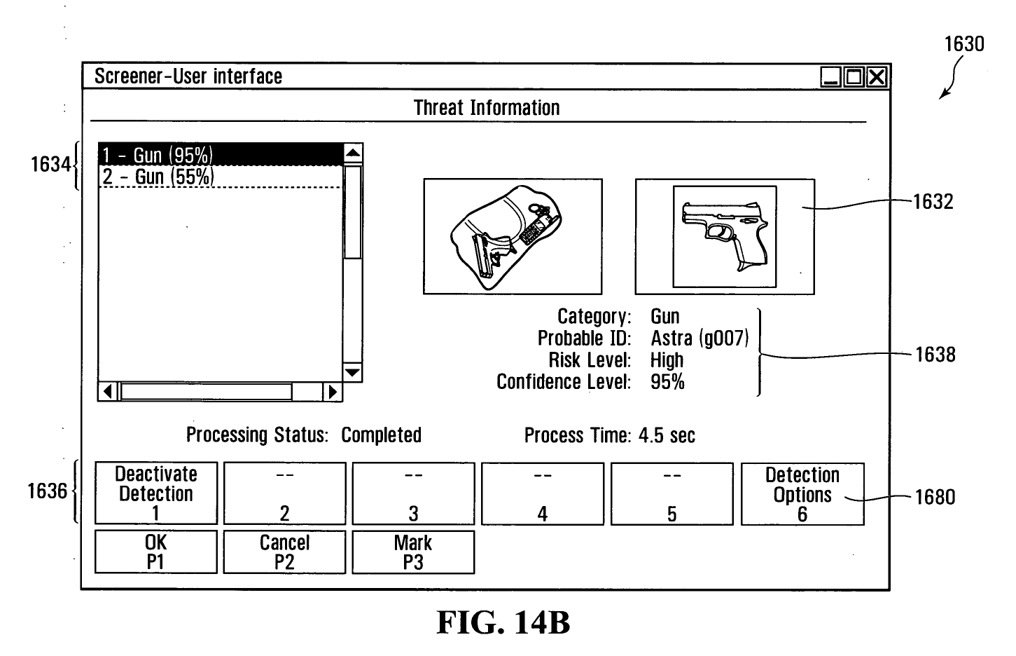

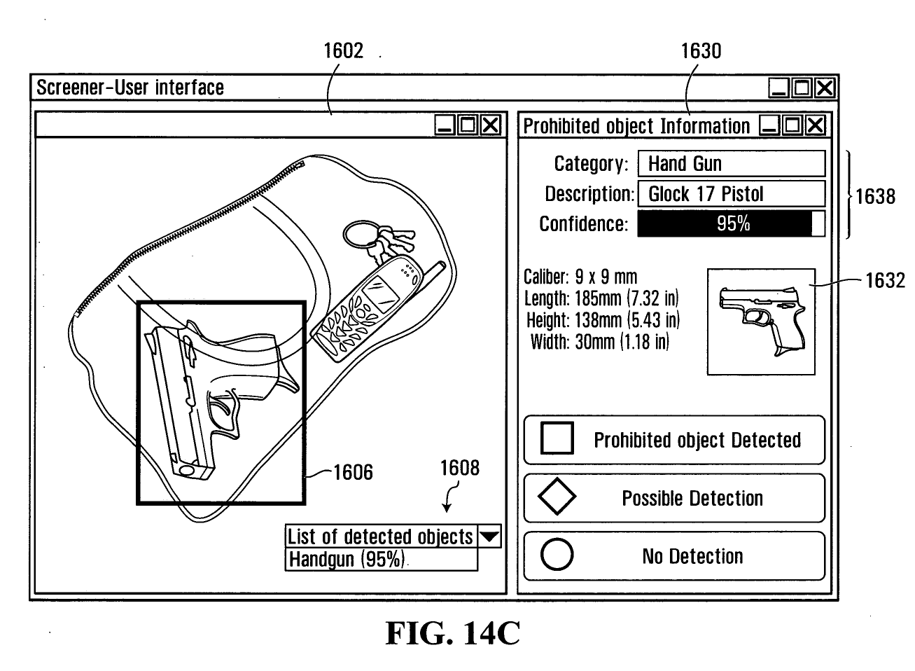

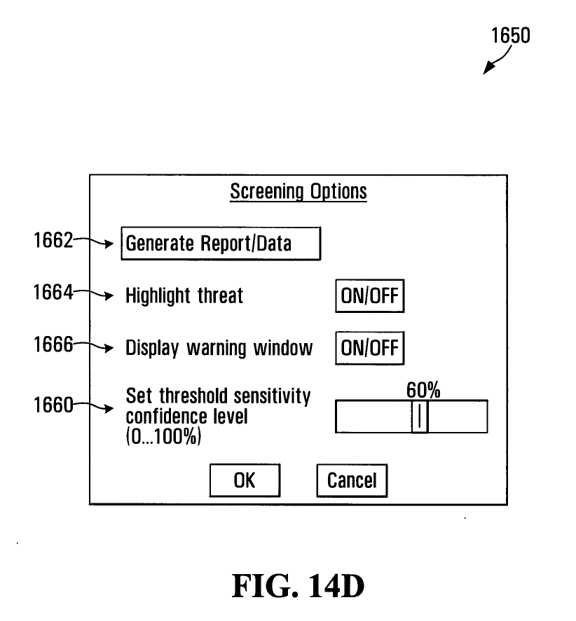

An example of the graphical user interface implemented by the apparatus 1510 is now described with reference to FIGS. 14A to 14D.

In this example, the graphical user interface displays first information 1604 conveying an input image related to contents of a receptacle, based on an image signal received at the input 1512 of the apparatus 1510. The input image may be in any suitable format and may depend on the format of the image signal received at the input 1512. For example, the input image may be of type x-ray, gamma-ray, computed tomography (CT), TeraHertz, millimeter wave, or emitted radiation, amongst others.

The graphical user interface also displays second information 1606 conveying a presence of one or more target objects in the receptacle based on the detection signal received at the input 1502 of the apparatus 1510. The second information 1606 is derived at least in part based on the detection signal received at the second input 1502. The second information 1606 may be displayed simultaneously with the first information 1604. In one case, the second information 1606 may convey position information regarding each of the at least one detected target object within the receptacle. The second information 1606 may convey the presence of one or more target objects in the receptacle in textual format, in graphical format, or as a combination of graphical information and textual information. In textual format, the second information 1606 may appear in a dialog box with a message such as “A ‘target_object_name’ has been detected.” or any conceivable variant. In the example shown in FIG. 14A, the second information 1606 includes graphic indicators in the form of circles positioned such as to identify the location of the one or more detected target objects in the input image associated with the receptacle. The location of the circles is derived on the basis of the content of the detection signal received at the input 1502. It will be appreciated that graphical indicators of any suitable shape (e.g. square, arrows, etc.) may be used to identify the location of the one or more detected target objects in the input image associated with the receptacle. Moreover, functionality may be provided to a user to allow the user to modify the appearance, such as the size, shape and/or color, of the graphical indicators used to identify the location of the one or more detected target objects.

The graphical user interface may also provide a control 1608 allowing a user to cause third information to be displayed, the third information conveying at least one characteristic associated to the one or more detected target objects. For example, the control 1608 may allow the user to cause the third information to be displayed by using an input device such as, for example, a mouse, keyboard, pointing device, speech recognition unit, touch sensitive screen, etc. In the example shown in FIG. 14A, the control 1608 is in the form of a selection box including an actuation button that can be selectively actuated by a user. In an alternative embodiment, a control may be provided as a physical button (or key) on a keyboard or other input device that can be selectively actuated by a user. In such an embodiment, the physical button (or key) is in communication with the apparatus 1510 through the user input 1550.

The first information 1604 and the second information 1606 may be displayed in a first viewing window 1602 as shown in FIG. 14A and the third information may be displayed in a second viewing window 1630 as shown in FIG. 14B. The first and second viewing windows 1602 and 1630 may be displayed concurrently on same display, concurrently on separate displays, or separately such that, when the second viewing window 1630 is displayed, the first viewing window 1602 is partially or fully concealed. The control 1608 may allow a user to cause the second viewing window 1630 displaying the third information to be displayed. FIG. 14C shows an alternative embodiment where the first and second viewing windows 1602 and 1630 are displayed concurrently.

With reference to FIG. 14B, in this embodiment, the second viewing window 1630 displays third information conveying at least one characteristic associated to the one or more detected target objects in the receptacle. The third information will vary from one implementation to another.

For example, in this case, the third information conveys, for each detected target object, an image 1632 and object characteristics 1638 including a description, a risk level, and a level of confidence for the detection. Other types of information that may be conveyed include, without being limited to: a handling procedure when such a target object is detected, dimensions of the detected target object, or any other information that could assist a user in validating other information that is provided, confirm presence of the detected target object or facilitate its handling, etc. The third information may be conveyed in textual formal, graphical format, or both. For instance, the third information may include information related to the level of confidence for the detection using a color scheme. An example of a possible color scheme that may be used may be:
red: threat positively detected;
yellow: possible threat detected; and
green: no threat detected.

As another example, the third information may include information related to the level of confidence for the detection using a shape scheme. Such a shape-based scheme to show information related to the level of confidence for the detection may be particularly useful for individuals who are color blind or for use with monochromatic displays. An example of a possible shape scheme that may be used may be:
diamond: threat positively detected;
triangle: possible threat detected; and
square: no threat detected.

In one embodiment, the processing unit 1506 is adapted to transmit a query signal to the database 110, on a basis of information conveyed by the detection signal received at the input 1502, in order to obtain certain information associated to one or more detected target objects, such as an image, a description, a risk level, and a handling procedure, amongst others. In response to the query signal, the database 110 transmits the requested information to the processing unit 1506 via the input 1504. Alternatively, a signal conveying information associated with the one or more detected target objects can be automatically provided to the apparatus 1510 without requiring a query.

With continued reference to FIG. 14B, the graphical user interface may display a detected target object list 1634 including one or more entries, each entry being associated to a respective detected target object. In this example, the detected target object list 1634 is displayed in the second viewing window 1630. The detected target object list 1634 may alternatively be displayed in the first viewing window 1602 or in yet another viewing window (not shown). As another possible alternative, the detected target object list 1634 may be displayed in the first viewing window 1602 and may perform the functionality of the control 1608. More specifically, in such a case, the control 1608 may be embodied in the form of a list of detected target objects including one or more entries each associated to a respective detected target object. This enables a user to select one or more entries from the list of detected target objects. In response to the user's selection, third information conveying at least one characteristic associated to the one or more selected detected target objects is caused to be displayed by the graphical user interface.

Each entry in the detected target object list 1634 may include information conveying a level of confidence associated to the presence of the corresponding target object in the receptacle. The information conveying a level of confidence may be extracted from the detection signal received at input 1502. For example, the processing unit 1506 may process a data element indicative of the level of confidence received in the detection signal in combination with a detection sensitivity level. When the level of confidence associated to the presence of a particular target object in the receptacle conveyed by the data element in the detection signal is below the detection sensitivity level, the second information 1606 associated with the particular target object is omitted from the graphical user interface. In addition, the particular target object is not listed in the detected target object list 1634. In other words, in that example, only information associated to target objects for which detection levels of confidence exceed the detection sensitivity level is provided by the graphical user interface.

Each entry in the detected target object list 1634 may include information conveying a threat level (not shown) associated to the corresponding detected target object. The information conveying a threat level may be extracted from the signal received from the database 110 received at the third input 1504. The threat level information associated to a particular detected object may convey the relative threat level of the particular detected target object compared to other target objects in the database 110. For example, a gun would be given a relatively high threat level while a metallic nail file would be given a relatively low threat level, and perhaps a pocket knife would be given a threat level between that of the nail file and the gun.

Functionality may be provided to a user for allowing the user to sort the entries in the detected target object list 1634 based on one or more selection criteria. Such criteria may include, without being limited to, the detection levels of confidence and/or the threat level. For example, such functionality may be enabled by displaying a control (not shown) on the graphical user interface in the form of a pull-down menu providing a user with a set of sorting criteria and allowing the user to select the criteria via an input device. In response to the user's selection, the entries in the detected target object list 1634 are sorted based on the criteria selected by the user. Other manners for providing such functionality will become apparent and as such will not be described further here.

Functionality may also be provided to the user for allowing the user to add and/or remove one or more entries in the detected target object list 1634. Removing an entry may be desirable, for example, when screening personnel observes the detection results and decides that the detection was erroneous or, alternatively, that the object detected is not particularly problematic. Adding an entry may be desirable, for example, when the screening personnel observes the presence of a target object, which was not detected, on the image displayed. When an entry from the detected target object list 1634 is removed/added, the user may be prompted to enter information conveying a reason why the entry was removed/added from/to the detected target object list 1634. Such information may be entered using any suitable input device such as, for example, a mouse, keyboard, pointing device, speech recognition unit, or touch sensitive screen, to name a few.

In this embodiment, the graphical user interface enables a user to select one or more entries from the detected target object list 1634 for which third information is to be displayed in the second viewing window 1630. For example, the user can select one or more entries from the detected target object list 1634 by using an input device. A signal conveying the user's selection is received at the user input 1550. In response to receiving that signal at the user input 1550, information associated with the one or more entries selected in the detected target object list 1634 is displayed in the second viewing window 1630.

The graphical user interface may be adapted for displaying a second control (not shown) for allowing a user to cause the second information to be removed from the graphical user interface.

The graphical user interface may also be adapted for displaying one or more additional controls 1636 for allowing a user to modify a configuration of the graphical user interface. For example, the graphical user interface may display a control window in response to actuation of a control button 1680 allowing a user to select screening options. An example of such a control window is shown in FIG. 14D. In this example, the user is enabled to select between the following screening options:
Generate a report data 1652. This option allows a report to be generated detailing information associated to the screening of the receptacle. In the example shown, this is done by providing a control in the form of a button that can be toggled between an “ON” state and an “OFF” state. It will be appreciated that other suitable forms of controls may be used. Examples of information contained in the report may include, without being limited to, a time of the screening, an identification of the security personnel operating the screening system, an identification of the receptacle and/or receptacle owner (e.g., passport number in the case of a customs screening), location information, an identification of the detected target object, and a description of the handling that took place and the results of the handling. This report allows a tracking of the screening operation.
Highlight detected target object 1664. This option allows a user to cause the second information 1606 to be removed from or displayed on the graphical user interface. In the example shown, this is done by providing a control in the form of a button that can be toggled between an “ON” state and an “OFF” state. It will be appreciated that other suitable forms of controls may be used.
Display warning window 1666. This option allows a user to cause a visual indicator in the form of a warning window to be removed from or displayed on the graphical user interface when a target object is detected in a receptacle.
Set threshold sensitivity/confidence level 1660. This option allows a user to modify the detection sensitivity level of the screening system. For example, this may be done by providing a control in the form of a text box, sliding ruler (as shown in FIG. 14D), selection menu, or other suitable type of control allowing the user to select between a range of detection sensitivity levels. It will be appreciated that other suitable forms of controls may be used.

It is to be understood that other options may be provided to a user and that of the above example options may be omitted in certain embodiments.

In addition, certain options may be selectively provided to certain users or, alternatively, may require a password to be provided. For example, the setting threshold sensitivity/confidence level 1660 may only be made available to user having certain privileges (e.g., screening supervisors or security directors). As such, the graphical user interface may include some type of user identification/authentication functionality, such as a login process, to identify/authenticate a user. Alternatively, the graphical user interface, upon selection by a user of the setting threshold sensitivity/confidence level 1660 option, may prompt the user to enter a password for allowing the user to modify the detection sensitivity level of the screening system.

The graphical user interface may be adapted to allow a user to add complementary information to the information being displayed on the graphical user interface. For example, the user may be enabled to insert markings in the form of text and/or visual indicators in an image displayed on the graphical user interface. The markings may be used, for example, to emphasize certain portions of the receptacle. The marked-up image may then be transmitted to a third party location, such as a checking station, so that the checking station is alerted to verify the marked portion of the receptacle to potentially locate a target object. In such an implementation, the user input 1550 receives signals from an input device, the signals conveying commands for marking the image displayed in the graphical user interface. Any suitable input device for providing user commands may be used such as, for example, a mouse, keyboard, pointing device, speech recognition unit, touch sensitive screen, etc.

The apparatus 1510 may be adapted to store a history of the image signals received at the first input 1512 conveying information related to the contents of previously screened receptacles. The image signals may be stored in association with the corresponding detection signals received at the input 1502 and any corresponding user input signals received at the input 1550. The history of prior images may be accessed through a suitable control (not shown) provided on the graphical user interface. The control may be actuated by a user to cause a list for prior images to be displayed to the user. The user may then be enabled to select one or more entries in the list of prior images. For instance, the selection may be effected on the basis of the images themselves or by allowing the user to specify either a time or time period associated to the images in the history of prior images. In response to a user selection, the one or more images from the history of prior images may then be displayed to the user along with information regarding the target objects detected in those images. When multiple images are selected, the selected images may be displayed concurrently with another or may be displayed separately.

The apparatus 1510 may also be adapted to assign a classification to a receptacle depending upon the detection signal received at the second input 1502. The classification criteria may vary from one implementation to another and may be further conditioned on a basis of external factors such as national security levels. The classification may be a two level classification, such as an “ACCEPTED/REJECTED” type of classification, or alternatively may be a multi-level classification. An example of a multi-level classification is a three level classification where receptacles are classified as “LOW/MEDIUM/HIGH RISK”. The classifications may then be associated to respective handling procedures. For example, receptacles classified as “REJECT” may be automatically assigned to be manually inspected while receptacles classified as “ACCEPTED” may proceed without such an inspection. In one embodiment, each class is associated to a set of criteria. Examples of criteria may include, without being limited to: a threshold confidence level associated to the detection process, the level of risk associated with the target object detection, and whether a target object was detected. It will be appreciated that other criteria may be used.

Apparatus 106

With reference to FIG. 3, there is shown an embodiment of the apparatus 106. In this embodiment, the apparatus 106 comprises a first input 310, a second input 314, an output 312, and a processing unit. The processing unit comprises a plurality of functional entities, including a pre-processing module 300, a distortion correction module 350, an image comparison module 302, and a detection signal generator module 306.

The first input 310 is adapted for receiving the image signal 150 associated with the receptacle 104 from the image generation device 102. It is recalled that the image signal 150 conveys the input image 800 related to the contents of the receptacle 104. The second input 314 is adapted for receiving data elements from the database 110, more specifically, filter data elements 414₁-414_{K} or image data elements 412₁-412_{K} associated with target objects. That is, in some embodiments, a data element received at the second input 314 may be a filter data element 414ₖ while in other embodiments, a data element received at the second input 314 may be an image data element 412ₖ. It will be appreciated that in embodiments where the database 110 is part of the apparatus 106, the second input 314 may be omitted. The output 312 is adapted for releasing, towards the output module 108, the detection signal 160 conveying the presence of one or more target objects in the receptacle 104.

Generally speaking, the processing unit of the apparatus 106 receives the image signal 150 associated with the receptacle 104 from the first input 310 and processes the image signal 150 in combination with the data elements associated with target objects (received from the database 110 at the second input 314) in an attempt to detect the presence of one or more target objects in the receptacle 104. In response to detection of one or more target objects (hereinafter referred to as “detected target objects”) in the receptacle 104, the processing unit of the apparatus 106 generates and releases at the output 312 the detection signal 160 which conveys the presence of the one or more detected target objects in the receptacle 104.

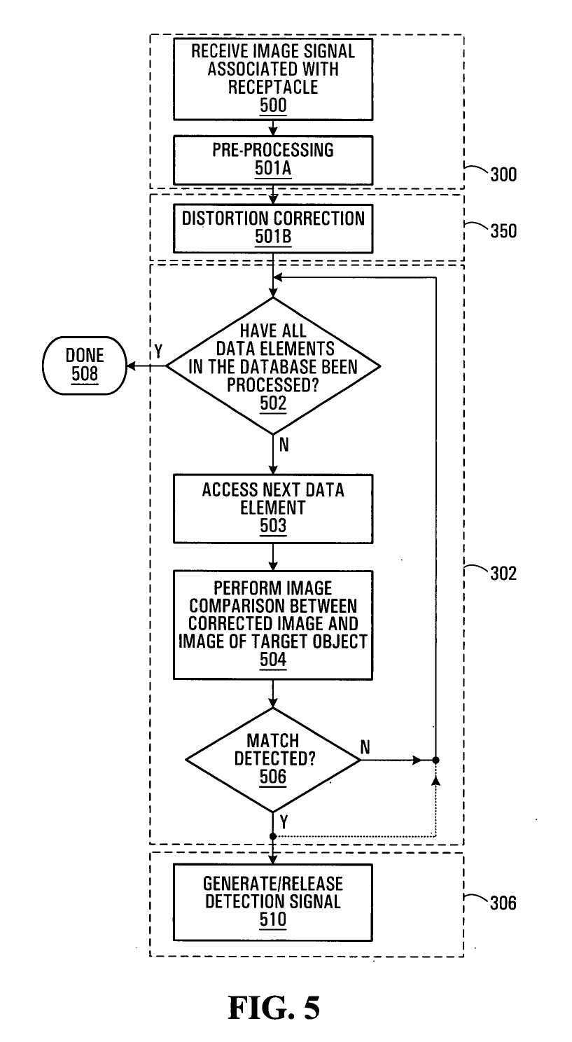

The functional entities of the processing unit of the apparatus 106 implement a process, an example of which is depicted in FIG. 5.

Step 500

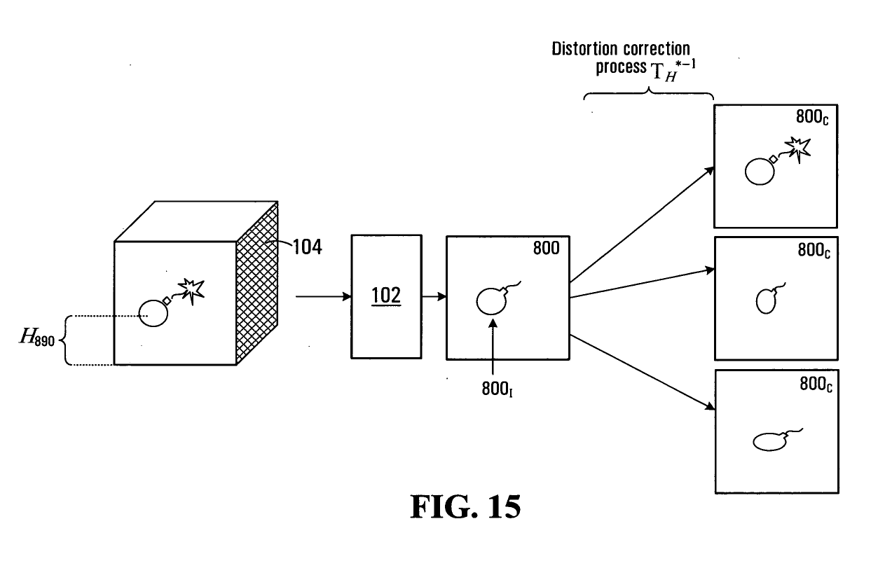

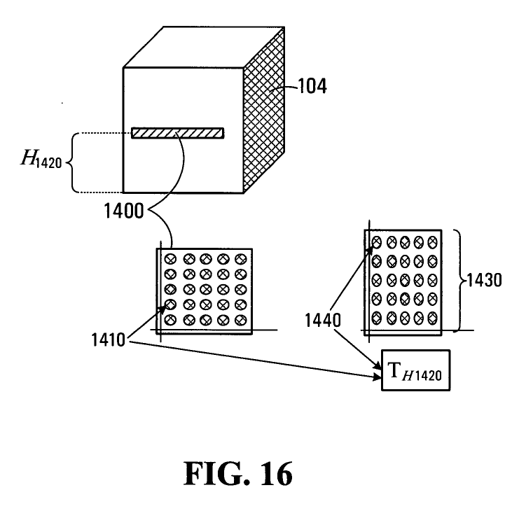

At step 500, the pre-processing module 300 receives the image signal 150 associated with the receptacle 104 via the first input 310. It is recalled that the image signal 150 conveys the input image 800 related to the contents of the receptacle 104.
   Step 501A
At step 501A, the pre-processing module 300 processes the image signal 150 in order to enhance the input image 800 related to the contents of the receptacle 104, remove extraneous information therefrom, and remove noise artefacts, thereby to help obtain more accurate comparison results later on. The complexity of the requisite level of pre-processing and the related trade-offs between speed and accuracy depend on the application. Examples of pre-processing may include, without being limited to, brightness and contrast manipulation, histogram modification, noise removal and filtering amongst others. As part of step 501A, the pre-processing module 300 releases a modified image signal 170 for processing by the distortion correction module 350 at step 501B. The modified image signal 170 conveys a pre-processed version of the input image 800 related to the contents of the receptacle 104.
   Step 501B
It is recalled at this point that, in some cases, the image generation device 102 may have introduced distortion into the input image 800 related to the contents of the receptacle 104. At step 501B, the distortion correction module 350 processes the modified image signal 170 in order to remove distortion from the pre-processed version of the input image 800. The complexity of the requisite amount of distortion correction and the related trade-offs between speed and accuracy depend on the application. As part of step 501B, the distortion correction module 350 releases a corrected image signal 180 for processing by the image comparison module 302 at step 502. The corrected image signal 180 conveys at least one corrected image related to the contents of the receptacle 104.
With additional reference to FIG. 15, distortion correction may be performed by applying a distortion correction process, which is referred to as T_{H}*⁻¹ for reasons that will become apparent later on. Ignoring for simplicity the effect of the pre-processing module 300, let the input image 800 be defined by intensity data for a set of observed coordinates, and let each of a set of one or more corrected images 800_{C} be defined by modified intensity data for a set of new coordinates. Applying the distortion correction process T_{H}*⁻¹ may thus consist of transforming the input image 800 (i.e., the intensity data for the set of observed coordinates) in order to arrive at the modified intensity data for the new coordinates in each of the corrected images 800_{C}.
Assuming that the receptacle 104 were flat (in the Z-direction), one could model the distortion introduced by the image generation device 102 as a spatial transformation T on a “true” image to arrive at the input image 800. Thus, T would represent a spatial transformation that models the distortion affecting a target object having a given shape and location in the “true” image, resulting in that object's “distorted” shape and location in the input image 800. Thus, to obtain the object's “true” shape and location, it is reasonable to want to make the distortion correction process resemble the inverse of T as closely as possible, so as to facilitate accurate identification of a target object in the input image 800. However, not only is T generally unknown in advance, but moreover it will actually be different for objects appearing at different heights within the receptacle 104.
More specifically, different objects appearing in the input image 800 may be distorted to different degrees, depending on the position of those objects within the input image 800 and depending on the height of those objects within the receptacle 104 (i.e., the distance between the object in question and the image generation device 102). Stated differently, assume that a particular target object 890 is located at a given height H₈₉₀ within the receptacle 104. An image taken of the particular target object 890 will manifest itself as a corresponding image element 800, in the input image 800, containing a distorted version of the particular target object 890. To account for the distortion of the shape and location of the image element 800, within the input image 800, one can still use the spatial transformation approach mentioned above, but this approach needs take into consideration the height H₈₉₀ at which the particular target object 890 appears within the receptacle 104. Thus, one can denote the spatial transformation for a given candidate height H by T_{H}, which therefore models the distortion affects the “true” images of target objects when such target objects are located at the candidate height H within the receptacle 104.
Now, although T_{H} is not known, it may be inferred, from which its inverse can be obtained. The inferred version of T_{H} is denoted T_{H}* and is hereinafter referred to as an “inferred spatial transformation” for a given candidate height H. Basically, T_{H}* can be defined as a data structure that represents an estimate of T_{H}. Although the number of possible heights that a target object may occupy is a continuous variable, it may be possible to granularize this number to a limited set of “candidate heights” (e.g., such as 5-10) without introducing a significant detection error. Of course, the number of candidate heights in a given embodiment may be as low as one, while the upper bound on the number of candidate heights is not particularly limited.
The data structure that represents the inferred spatial transformation T_{H}* for a given candidate height H may be characterized by a set of parameters derived from the coordinates of a set of “control points” in both the input image 800 and an “original” image for that candidate height. An “original” image for a given candidate height would contain non-distorted images of objects only if those images appeared within the receptacle 104 at the given candidate height. Of course, while the original image for a given candidate height is unknown, it may be possible to identify picture elements in the input image portion that are known to have originated from specific picture elements in the (unknown) original image. Thus, a “control point” corresponds to a picture element that occurs at a known location in the original image for a given candidate height H, and whose “distorted” position can be located in the input image 800.
In one non-limiting embodiment, to obtain control points specific to a given image generation device 102, and with reference to FIG. 16, one can use a template 1400 having a set of spaced apart holes 1410 at known locations in the horizontal and vertical directions. The template is placed at a given candidate height H₁₄₂₀. One then acquires an input image 1430, from which control points 1440 (i.e., the holes 1410 present at known locations in the template) are identified in the input image 1430. This may also be referred to as “a registration process”. Having performed the registration process on the input image 1430 that was derived from the template 1400, one obtains T_{H1420}*, the inferred spatial transformation for the height H₁₄₂₀.
To obtain the inferred spatial transformation T_{H}* for a given candidate height H, one may utilize a “transformation model”. The transformation model that is used may fall into one or more of the following non-limiting categories, depending on the type of distortion that is sought to be corrected:
   linear conformal;
   affine;
   projective
   polynomial warping (first order, second order, etc.);
   piecewise linear;
   local weighted mean;
   etc.
The use of the function cp2tform in the Image Processing Toolbox of Matlab® (available from Mathworks Inc.) is particularly suitable for the computation of inferred spatial transformations such as T_{H}* based on coordinates for a set of control points. Other techniques will now be apparent to persons skilled in the art to which the present invention pertains.
The above process can be repeated several times, for different candidate heights, thus obtaining T_{H}* for various candidate heights. It is noted that the derivation of T_{H}* for various candidate heights can be performed off-line, i.e., before scanning of the receptacle 104. In fact, the derivation of T_{H}* is independent of the contents of the receptacle 104.
Returning now to FIG. 15, and assuming that T_{H}* for a given set of candidate heights has been obtained (e.g., retrieved from memory), one inverts these transformations and applies the inverted transformations (denoted T_{H}*⁻¹) to the input image 800 in order to obtain the corrected images 800_{C}. This completes the distortion correction process.
It is noted that inverting T_{H}* for the various candidate heights yields a corresponding number of corrected images 800_{C}. Those skilled in the art will appreciate that each of the corrected images 800_{C} will contain areas of reduced distortion where those areas contained objects located at the candidate height for which the particular corrected image 800_{C} was generated.
It will be appreciated that T_{H}*⁻¹ is not always computable in closed form based on the corresponding T_{H}*. Nevertheless, the corrected image 800_{C} for the given candidate height can be obtained from the input image 800 using interpolation methods, based on the corresponding T_{H}*. Examples of suitable interpolation methods that may be used include bicubic, bilinear and nearest-neighbor, to name a few.
The use of the function imtransform in the Image Processing Toolbox of Matlab® (available from Mathworks Inc.) is particularly suitable for the computation of an output image (such as one of the corrected images 800_{C}) based on an input image (such as the input image 800) and an inferred spatial transformation such as T_{H}*. Other techniques will now be apparent to persons skilled in the art to which the present invention pertains.
It is noted that certain portions of the corrected image 800_{C} for a given candidate height might not exhibit less distortion than in the input image 800, for the simple reason that the objects contained in those portions appeared at a different height within the receptacle 104 when they were being scanned. Nevertheless, if a certain target object was in the receptacle 104, then it is likely that at least one portion of the corrected image 800_{C} for at least one candidate height will show a reduction in distortion with respect to representation of the certain target object in the input image 800, thus facilitating comparison with data elements in the database 110 as described later on.
Naturally, the precise numerical values in the transformations used in the selected distortion correction technique may vary from one image generation device 102 to another, as different image generation devices introduce different amounts of distortion of different types, which appear in different regions of the input image 800.
Of course, those skilled in the art will appreciate that similar reasoning and calculations apply when taking into account the effect of the pre-processing module 300, the only difference being that one would be dealing with observations made in the pre-processed version of the input image 800 rather than in the input image 800 itself.
It will also be appreciated that the functionality of the pre-processing module 300 and the distortion correction module 350 can be performed in reverse order. In other embodiments, all or part of the functionality of the pre-processing module 300 and/or the distortion correction module 350 may be external to the apparatus 106, e.g., such functionality may be integrated with the image generation device 102 or performed by external components. It will also be appreciated that the pre-processing module 300 and/or the distortion correction module 350 (and hence steps 501A and/or 501B) may be omitted in certain embodiments of the present invention.
   Step 502
At step 502, the image comparison module 302 verifies whether there remain any unprocessed data elements (i.e., filter data elements 414₁-414_{K} or image data elements 412₁-412_{K}, depending on which of these types of data elements is used in a comparison effected by the image comparison module 302) in the database 110. In the affirmative, the image comparison module 302 proceeds to step 503 where the next data element is accessed and the image comparison module 302 then proceeds to step 504. If at step 502 all of the data elements in the database 110 have been processed, the image comparison module 302 proceeds to step 508 and the process is completed.
   Step 504
Assuming for the moment that the data elements received at the second input 314 are image data elements 412₁-412_{K} associated images of target objects, the data element accessed at step 503 conveys a particular image of a particular target object. Thus, in this embodiment, at step 504, the image comparison module 302 effects a comparison between at least one corrected image related to the contents of the receptacle 104 (which is conveyed in the corrected image signal 180) and the particular image of the particular target object to determine whether a match exists. It is noted that more than one corrected image may be provided, namely when more than one candidate height is accounted for. The comparison may be effected using any image processing algorithm suitable for comparing two images. Examples of algorithms that can be used to perform image processing and comparison include without being limited to:
A-ENHANCEMENT: Brightness and contrast manipulation; Histogram modification; Noise removal; Filtering.
B-SEGMENTATION: Thresholding; Binary or multilevel; Hysteresis based; Statistics/histogram analysis; Clustering; Region growing; Splitting and merging; Texture analysis; Watershed; Blob labeling;
C-GENERAL DETECTION: Template matching; Matched filtering; Image registration; Image correlation; Hough transform;
D-EDGE DETECTION: Gradient; Laplacian;
E-MORPHOLOGICAL IMAGE PROCESSING: Binary; Grayscale;
F-FREQUENCY ANALYSIS: Fourier Transform; Wavelets;
G-SHAPE ANALYSIS AND REPRESENTATIONS: Geometric attributes (e.g. perimeter, area, euler number, compactness); Spatial moments (invariance); Fourier descriptors; B-splines; Chain codes; Polygons; Quad tree decomposition;
H-FEATURE REPRESENTATION AND CLASSIFICATION: Bayesian classifier; Principal component analysis; Binary tree; Graphs; Neural networks; Genetic algorithms; Markov random fields.
The above algorithms are well known in the field of image processing and as such will not be described further here.
In one embodiment, the image comparison module 302 includes an edge detector to perform part of the comparison at step 504.
In another embodiment, the comparison performed at step 504 includes effecting a “correlation operation” between the at least one corrected image related to the contents of the receptacle 104 (which is conveyed in the corrected image signal 180) and the particular image of the particular target object. Again, it is recalled that when multiple candidate heights are accounted for, then multiple corrected images may need to be processed, either serially, in parallel, or a combination thereof.
For example, the correlation operation may involve computing the Fourier transform of the at least one corrected image related to the contents of the receptacle 104 (which is conveyed in the corrected image signal 180), computing the Fourier transform complex conjugate of the particular image of the particular target object, multiplying the two Fourier transforms together, and then taking the Fourier transform (or inverse Fourier transform) of the product. Simply put, the result of the correlation operation provides a measure of the degree of similarity between the two images.
In this embodiment, the correlation operation is performed by a digital correlator.
The image comparison module 302 then proceeds to step 506.
   Step 506
The result of the comparison effected at step 504 is processed to determine whether a match exists between (I) at least one of the at least one corrected image 800_{C} related to the contents of the receptacle 104 and (II) the particular image of the particular target object. In the absence of a match, the image comparison module 302 returns to step 502. However, in response to detection of a match, it is concluded that the particular target object has been detected in the receptacle and the image comparison module 302 triggers the detection signal generation module 306 to execute step 510. Then, the image comparison module 302 returns to step 502 to continue processing with respect to the next data element in the database 100.
   Step 510
At step 510, the detection signal generation module 306 generates the aforesaid detection signal 160 conveying the presence of the particular target object in the receptacle 104. The detection signal 160 is released via the output 312. The detection signal 160 may simply convey the fact that the particular target object has been detected as present in the receptacle 104, without necessarily specifying the identity of the particular target object. Alternatively, the detection signal 160 may convey the actual identity of the particular target object. As previously indicated, the detection signal 160 may include information related to the position of the particular target object within the receptacle 104 and optionally a target object identifier associated with the particular target object.
It should be noted that generation of the detection signal 160 may also be deferred until multiple or even all of the data elements in the database 110 have been processed. Accordingly, the detection signal may convey the detection of multiple target objects in the receptacle 104, their respective positions, and/or their respective identities.

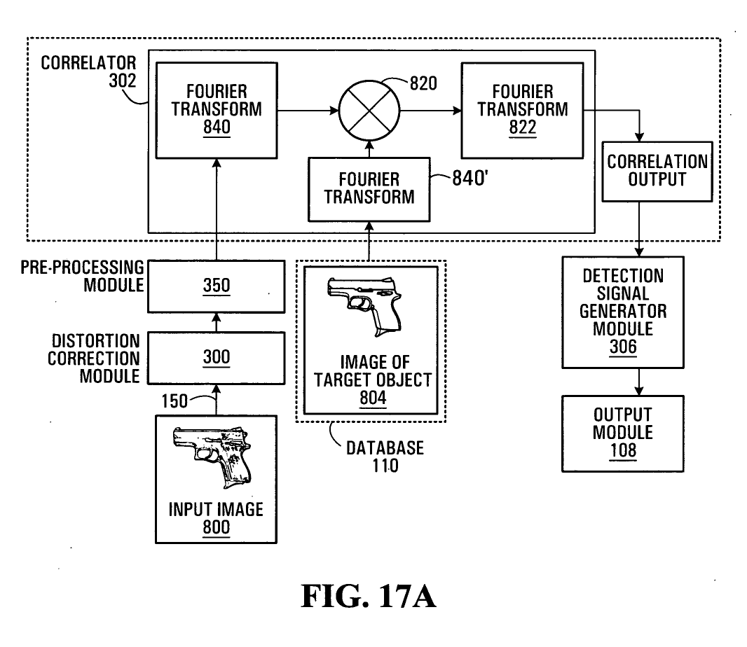

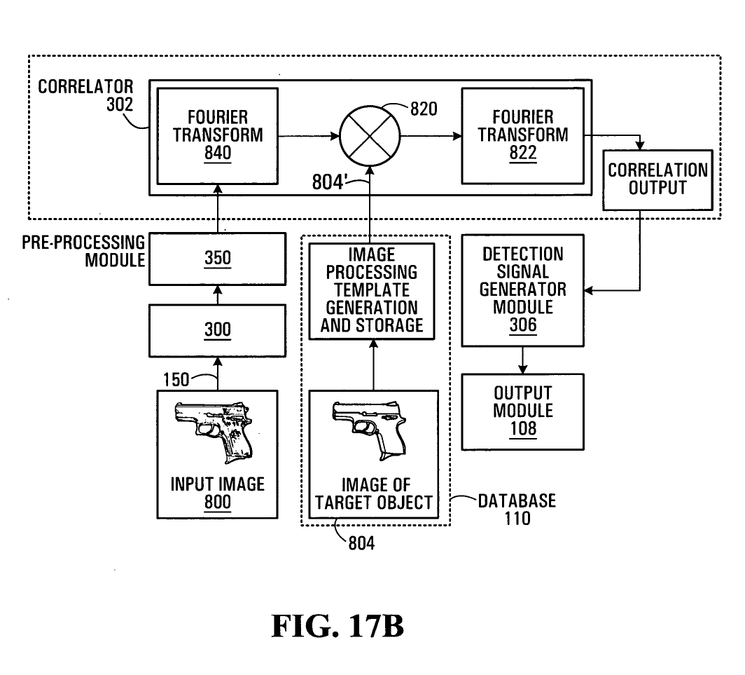

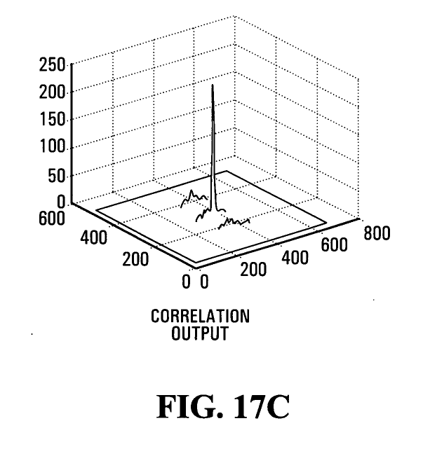

As mentioned above, in this embodiment, the correlation operation is performed by a digital correlator. Two examples of implementation of a suitable correlator 302 are shown in FIGS. 17A and 17B.

In a first example of implementation, now described with reference to FIG. 17A, the correlator 302 effects a Fourier transformation 840 of a given corrected image related to the contents of the receptacle 104. Also, the correlator 302 effects a complex conjugate Fourier transformation 840′ of a particular image 804 of a particular target object obtained from the database 110. Image processing and enhancement, as well as distortion pre-emphasis, can also be performed on the particular image 804 to obtain better matching performance depending on the environment and application. The result of the two Fourier transformations is multiplied 820. The correlator 302 then processes the result of the multiplication of the two Fourier transforms by applying another Fourier transform (or inverse Fourier transform) 822. This yields the correlation output, shown at FIG. 17C, in a correlation plane. The correlation output is released for transmission to the detection signal generator module 306 where it is analyzed. A peak in the correlation output (see FIG. 17C) indicates a match between the input image 800 related to the contents of the receptacle 104 and the particular image 804 of the particular target object. Also, the position of the correlation peak corresponds in fact to the location of the target object center in the input image 800. The result of this processing is then conveyed to the user by the output module 108.

In a second example of implementation, now described with reference to FIG. 17B, the data elements received from the database 110 are filter data elements 414₁-414_{K}, which as mentioned previously, may be indicative of the Fourier transform of the images of the target objects that the system 100 is designed to detect. In one case, the filter data elements 414₁-414_{K} are digitally pre-computed such as to improve the speed of the correlation operation when the system 100 is in use. Image processing and enhancement, as well as distortion pre-emphasis, can also be performed on the image of a particular target object to obtain better matching performance depending on the environment and application.

In this second example of implementation, the data element accessed at step 503 thus conveys a particular filter 804′ for a particular image 804. Thus, in a modified version of step 504, and with continued reference to FIG. 17B, the image comparison module 302 implements a correlator 302 for effecting a Fourier transformation 840 of a given corrected image related to the contents of the receptacle 104. The result is multiplied 820 with the (previously computed) particular filter 804′ for the particular image 804, as accessed from the database 110. The correlator 302 then processes the product by applying the optical Fourier transform (or inverse Fourier transform) 822. This yields the correlation output, shown at FIG. 17C, in a correlation plane. The correlation output is released for transmission to the detection signal generator module 306 where it is analyzed. A peak in the correlation output (see FIG. 17C) indicates a match between the input image 800 related to the contents of the receptacle 104 and the particular filter 804′ for the particular image 804. Also, the position of the correlation peak corresponds in fact to the location of the target object center in the input image 800.

More specifically, the detection signal generator module 306 is adapted for processing the correlation output to detect peaks. A strong intensity peak in the correlation output indicates a match between the input image 800 related to the contents of the receptacle 104 and the particular image 804. The location of the peak also indicates the location of the center of the particular image 804 in the input image 800 related to the contents of the receptacle 104.

The result of this processing is then conveyed to the user by the output module 108.

For more information regarding Fourier transforms, the reader is invited to consider B. V. K. Vijaya Kumar, Marios Savvides, Krithika Venkataramani, and Chunyan Xie, “Spatial frequency domain image processing for biometric recognition”, Biometrics ICIP Conference 2002 or alternatively J. W. Goodman, Introduction to Fourier Optics, 2nd Edition, McGraw-Hill, 1996, which is hereby incorporated by reference herein.

Fourier Transform and Spatial Frequencies

The Fourier transform as applied to images will now be described in general terms. The Fourier transform is a mathematical tool used to convert the information present within an object's image into its frequency representation. In short, an image can be seen as a superposition of various spatial frequencies and the Fourier transform is a mathematical operation used to compute the intensity of each of these frequencies within the image. The spatial frequencies represent the rate of variation of image intensity in space. Consequently, a smooth or uniform pattern mainly contains low frequencies. Sharply contoured patterns, by contrast, exhibit a higher frequency content.

The Fourier transform of an image f(x,y) is given by:
F(u,v)=∫∫f(x,y)e^{-j2π(ux+vy)}dxdy (1)
where u, v are the coordinates in the frequency domain. Thus, the Fourier transform is a global operator: changing a single frequency of the Fourier transform affects the whole object in the spatial domain.

A correlation operation can be mathematically described by:

$$C ( ɛ , ξ ) = {\int }_{- ∞}^{∞} {\int }_{- ∞}^{∞} f ( x , y ) h * ( x - ɛ , y - ξ ) ⅆ x ⅆ y \qquad ( 2 )$$

where ε and ξ represent the pixel coordinates in the correlation plane, C(ε,ξ) stands for the correlation, x and y identify the pixel coordinates of the input image, f(x, y) is the original input image, and h*(ε,ξ) is the complex conjugate of the correlation filter.

In the frequency domain, the same expression takes a slightly different form:
C(ε,ξ)=ℑ⁻¹(F(u,v)H*(u,v)) (3)
where ℑ is the Fourier transform operator, u and v are the pixel coordinates in the Fourier plane, F(u,v) is the Fourier transform of the image f(x,y), and H*(u,v) is the Fourier transform complex conjugate of the template (or filter). Thus, the correlation between an input image and a template (or filter) is equivalent, in mathematical terms, to the multiplication of their respective Fourier transforms, provided that the complex conjugate of the template (or filter) is used. Consequently, the correlation can be defined in the spatial domain as the search for a given pattern (template/filter), or in the frequency domain, as filtering operation with a specially designed matched filter.

In order to speed up the computation of the correlation, the Fourier transform of a particular image can be computed beforehand and submitted to the correlator as a filter (or template). This type of filter is called a matched filter.

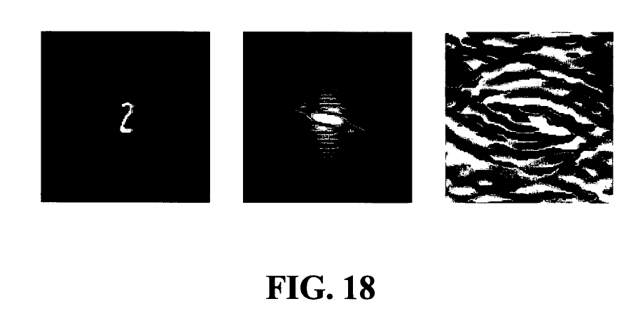

FIG. 18 depicts the Fourier transform of the spatial domain image of a number ‘2’. It can be seen that most of the energy (bright areas) is contained in the central portion of the Fourier transform image which correspond to low spatial frequencies (the images are centered on the origin of the Fourier plane). The energy is somewhat more dispersed in the medium frequencies and is concentrated in orientations representative of the shape of the input image. Finally, little energy is contained in the upper frequencies. The right-hand-side image shows the phase content of the Fourier transform. The phase is coded from black (0°) to white (360°).

Generation of Filters (or Templates)

Matched filters, as their name implies, are specifically adapted to respond to one image in particular: they are optimized to respond to an object with respect to its energy content. Generally, the contour of an object corresponds to its high frequency content. This can be easily understood as the contour represent areas where the intensity varies rapidly (hence a high frequency).

In order to emphasize the contour of an object, the matched filter can be divided by its module (the image is normalized), over the whole Fourier transform image. The resulting filter is called a Phase-Only Filter (POF) and is defined by:

$$P O F ( u , v ) = \frac{H * ( u , v )}{\vert H * ( u , v ) \vert} \qquad ( 4 )$$

The reader is invited to refer to the following document, which is hereby incorporated herein by reference, for additional information regarding phase only filters (POF): “Phase-Only Matched Filtering”, Joseph L. Horner and Peter D. Gianino, Appl. Opt. Vol. 23 no. 6, 15 Mar. 1994, pp. 812-816.

Because these filters are defined in the frequency domain, normalizing over the whole spectrum of frequencies implies that each of the frequency components is considered with the same weight. In the spatial domain (e.g., usual real-world domain), this means that the emphasis is given to the contours (or edges) of the object. As such, the POF filter provides a higher degree of discrimination, sharper correlation peaks and higher energy efficiency.

The discrimination provided by the POF filter, however, has some disadvantages. It turns out that, the images are expected to be properly sized, otherwise the features might not be registered properly. To understand this requirement, imagine a filter defined out of a given instance of a ‘2’. If that filter is applied to a second instance of a ‘2’ whose contour is slightly different, the correlation peak will be significantly reduced as a result of the sensitivity of the filter to the original shape. A different type of filter, termed a composite filter, was introduced to overcome these limitations. The reader is invited to refer to the following document, which is hereby incorporated herein by reference, for additional information regarding this different type of composite filter: H. J. Caufield and W. T. Maloney, Improved Discrimination in Optical Character Recognition, Appl. Opt., 8, 2354, 1969.

In accordance with specific implementations, filters can be designed by:
appropriately choosing one specific instance (because it represents characteristics which are, on average, common to all symbols of a given class) of a symbol and calculating from that image the filter against which all instances of that class of symbols will be compared; or
averaging many instances of a given symbol to create a generic or ‘template’ image from which the filter is calculated. The computed filter is then called a composite filter since it incorporates the properties of many images (note that it is irrelevant whether the images are averaged before or after the Fourier transform operator is applied, provided that in the latter case, the additions are performed taking the Fourier domain phase into account).

The latter procedure forms the basis for the generation of composite filters. Thus composite filters are composed of the response of individual POF filters to the same symbol. Mathematically, this can be expressed by:
h_{comp}(x,y)=αₐhₐ(x,y)+α_{b}h_{b}(x,y)+ . . . +αₓhₓ(x,y) (5)

A filter generated in this fashion is likely to be more robust to minor signature variations as the irrelevant high frequency features will be averaged out. In short, the net effect is an equalization of the response of the filter to the different instances of a given symbol.

Composite filters can also be used to reduce the response of the filter to the other classes of symbols. In equation (5) above, if the coefficient b, for example, is set to a negative value, then the filter response to a symbol of class b will be significantly reduced. In other words, the correlation peak will be high if hₐ(x,y) is at the input image, and low if h_{b}(x,y) is present at the input. A typical implementation of composite filters is described in: Optical Character Recognition (OCR) in Uncontrolled Environments Using Optical Correlators, Andre Morin, Alain Bergeron, Donald Prevost and Ernst A. Radloff, Proc. SPIE Int. Soc. Opt. Eng. 3715, 346 (1999), which is hereby incorporated herein by reference.

Screening of People

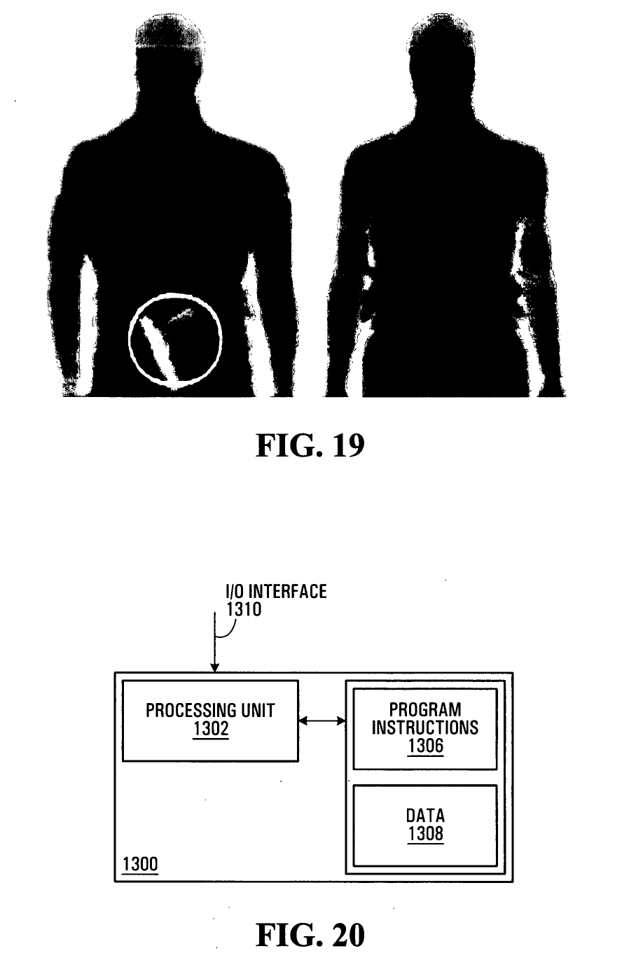

It will be appreciated that the concepts described above can also be readily applied to the screening of people. For example, in an alternative embodiment, a system for screening people is provided. The system includes components similar to those described in connection with the system depicted in FIG. 1. In a specific example of implementation, the image generation device 102 is configured to scan a person and possibly to scan the person along various axes to generate multiple images associated with the person. The image(s) associated with the person convey information related to the objects carried by the person. FIG. 19 depicts two images associated with a person suitable for use in connection with a specific implementation of the system. Each image is then processed in accordance with the method described in the present specification to detect the presence of target objects on the person.

Examples of Physical Implementation

It will be appreciated that, in some embodiments, certain functionality of various components described herein (including the apparatus 106) can be implemented on a general purpose digital computer 1300, an example of which is shown in FIG. 20, including a processing unit 1302 and a memory 1304 connected by a communication bus. The memory 1304 includes data 1308 and program instructions 1306. The processing unit 1302 is adapted to process the data 1308 and the program instructions 1306 in order to implement functionality described in the specification and depicted in the drawings. The digital computer 1300 may also comprise an I/O interface 1310 for receiving or sending data from or to external devices.

In other embodiments, certain functionality of various components described herein (including the apparatus 106) can be implemented using pre-programmed hardware or firmware elements (e.g., application specific integrated circuits (ASICs), electrically erasable programmable read-only memories (EEPROMs), etc.) or other related elements.

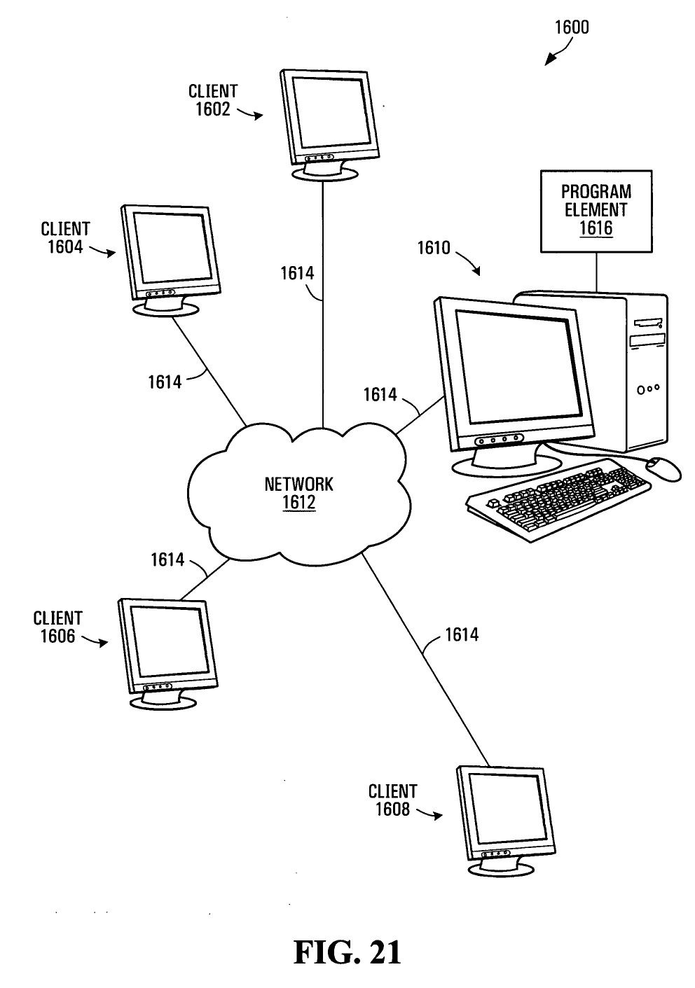

It will also be appreciated that the system 100 depicted in FIG. 1 may also be of a distributed nature whereby image signals associated with receptacles or persons are obtained at one or more locations and transmitted over a network to a server unit implementing functionality described herein. The server unit may then transmit a signal for causing an output unit to display information to a user. The output unit may be located in the same location where the image signals associated with the receptacles or persons were obtained or in the same location as the server unit or in yet another location. In one case, the output unit may be part of a centralized screening facility. FIG. 21 illustrates an example of a network-based client-server system 1600 for screening receptacles or persons. The client-server system 1600 includes a plurality of client systems 1602, 1604, 1606 and 1608 connected to a server system 1610 through a network 1612. Communication links 1614 between the client systems 1602, 1604, 1606 and 1608 and the server system 1610 may be metallic conductors, optical fibres, wireless, or a combination thereof. The network 1612 may be any suitable network including but not limited to a global public network such as the Internet, a private network, and a wireless network. The server system 1610 may be adapted to process and issue signals concurrently using suitable methods known in the computer related arts.

The server system 1610 includes a program element 1616 for execution by a CPU. Program element 1616 includes functionality to implement methods described above and includes the necessary networking functionality to allow the server system 1610 to communicate with the client systems 1602, 1604, 1606 and 1608 over network 1612. In a specific implementation, the client systems 1602, 1604, 1606 and 1608 include display units responsive to signals received from the server system 1610 for displaying information to viewers of these display units.

Although the present invention has been described in considerable detail with reference to certain preferred embodiments thereof, variations and refinements are possible without departing from the spirit of the invention. Therefore, the scope of the invention should be limited only by the appended claims and their equivalents.

1. Apparatus for performing a security screening operation on receptacles to detect presence of one or more prohibited objects in the receptacles, said apparatus comprising:
an input for receiving image data conveying an image of contents of a currently screened receptacle, the image data being derived from a device that scans the currently screened receptacle with penetrating radiation;
a processing unit, for determining whether the image depicts at least one prohibited object;
a storage component for storing history image data associated with images of contents of receptacles previously screened by said apparatus; and
a graphical user interface for displaying a representation of the contents of the currently screened receptacle on a basis of the image data, said graphical user interface being adapted for displaying a representation of the contents of each of at least one of the receptacles previously screened by said apparatus on a basis of the history image data.

2. Apparatus as claimed in claim 1, wherein said graphical user interface is adapted for displaying concurrently a representation of the contents of each of plural ones of the receptacles previously screened by said apparatus on a basis of the history image data.

3. Apparatus as claimed in claim 1, wherein said graphical user interface is adapted for providing at least one control allowing a user to cause said graphical user interface to display the representation of the contents of each of at least one of the receptacles previously screened by said apparatus.

4. Apparatus as claimed in claim 2, wherein said graphical user interface is adapted for providing at least one control allowing a user to cause said graphical user interface to display concurrently the representation of the contents of each of plural ones of the receptacles previously screened by said apparatus.

5. Apparatus as claimed in claim 1, wherein said processing unit is adapted for processing the image data and data associated with a plurality of prohibited objects to be detected to determine whether the image depicts at least one of the prohibited objects.

6. Apparatus as claimed in claim 5, wherein the data associated with a plurality of prohibited objects to be detected comprises a plurality of data elements respectively associated with the prohibited objects to be detected, said processing comprising, for each particular one of the data elements, effecting a correlation operation between the image data and the particular one of the data elements.

7. Apparatus as claimed in claim 1, wherein said graphical user interface is adapted for, when said processing unit determines that the image depicts at least one prohibited object, highlighting a location of each of the at least one prohibited object on the representation of the contents of the currently screened receptacle.

8. Apparatus as claimed in claim 7, wherein said graphical user interface is adapted for highlighting the location of each of the at least one prohibited object on the representation of the contents of the currently screened receptacle by displaying, for each of the at least one prohibited object, a graphical indicator indicating the location of that prohibited object on the representation of the contents of the currently screened receptacle.

9. Apparatus as claimed in claim 1, wherein said graphical user interface is adapted for providing at least one control allowing a user to select whether or not said graphical user interface, when said processing unit determines that the image depicts at least one prohibited object, highlights a location of each of the at least one prohibited object on the representation of the contents of the currently screened receptacle.

10. Apparatus as claimed in claim 9, wherein said graphical user interface is adapted to highlight the location of each of the at least one prohibited object on the representation of the contents of the currently screened receptacle by displaying, for each of the at least one prohibited object, a graphical indicator indicating the location of that prohibited object on the representation of the contents of the currently screened receptacle.

11. A computer implemented graphical user interface for use in performing a security screening operation on receptacles to detect presence of one or more prohibited objects in the receptacles, said computer implemented graphical user interface comprising a component for displaying a representation of contents of a currently screened receptacle, the representation of contents of a currently screened receptacle being derived from image data conveying an image of the contents of the currently screened receptacle, the image data being derived from a device that scans the currently screened receptacle with penetrating radiation, said computer implemented graphical user interface being adapted for displaying a representation of contents of each of at least one of a plurality of previously screened receptacles, the representation of contents of each of at least one of a plurality of previously screened receptacles being derived from history image data associated with images of the contents of the previously screened receptacles.

12. A method for performing a security screening operation on receptacles to detect presence of one or more prohibited objects in the receptacles, said method comprising:
receiving image data conveying an image of contents of a currently screened receptacle, the image data being derived from a device that scans the currently screened receptacle with penetrating radiation;
processing the image data to determine whether the image depicts at least one prohibited object;
storing history image data associated with images of contents of previously screened receptacles; and
displaying on a graphical user interface a representation of the contents of the currently screened receptacle on a basis of the image data; and
displaying on the graphical user interface a representation of the contents of each of at least one of the previously screened receptacles on a basis of the history image data.

13. A method as claimed in claim 12, wherein said displaying on the graphical user interface a representation of the contents of each of at least one of the previously screened receptacles comprises displaying concurrently on the graphical user interface a representation of the contents of each of plural ones of the previously screened receptacles on a basis of the history image data.

14. A method as claimed in claim 12, comprising providing at least one control allowing a user to cause the graphical user interface to display the representation of the contents of each of at least one of the previously screened receptacles.

15. A method as claimed in claim 13, comprising providing at least one control allowing a user to cause the graphical user interface to display the representation of the contents of each of plural ones of the previously screened receptacles.

16. A method as claimed in claim 12, wherein said processing comprises processing the image data and data associated with a plurality of prohibited objects to be detected to determine whether the image depicts at least one of the prohibited objects.

17. A method as claimed in claim 16, wherein the data associated with a plurality of prohibited objects to be detected comprises a plurality of data elements respectively associated with the prohibited objects to be detected, said processing comprising, for each particular one of the data elements, effecting a correlation operation between the image data and the particular one of the data elements.

18. A method as claimed in claim 12, comprising, upon determining that the image depicts at least one prohibited object, highlighting a location of each of the at least one prohibited object on the representation of the contents of the currently screened receptacle.

19. A method as claimed in claim 18, wherein said highlighting comprises displaying, for each of the at least one prohibited object, a graphical indicator indicating the location of that prohibited object on the representation of the contents of the currently screened receptacle.

20. A method as claimed in claim 12, comprising providing at least one control allowing a user to select whether or not the graphical user interface, upon determining that the image depicts at least one prohibited object, highlights a location of each of the at least one prohibited object on the representation of the contents of the currently screened receptacle.

21. A method as claimed in claim 20, wherein highlighting the location of each of the at least one prohibited object on the representation of the contents of the currently screened receptacle comprises displaying, for each of the at least one prohibited object, a graphical indicator indicating the location of that prohibited object on the representation of the contents of the currently screened receptacle.

22. Apparatus for performing a security screening operation on receptacles to detect presence of one or more prohibited objects in the receptacles, said apparatus comprising:
an input for receiving image data conveying an image of contents of a receptacle, the image data being derived from a device that scans the receptacle with penetrating radiation;
a processing unit for determining whether the image depicts at least one prohibited object; and
a graphical user interface for:
displaying a representation of the contents of the receptacle on a basis of the image data; and
providing at least one control allowing a user to select whether or not said graphical user interface highlights on the representation of the contents of the receptacle a location of each of at least one prohibited object deemed to be depicted in the image.

23. Apparatus as claimed in claim 22, wherein the at least one control comprises a first control adapted to be toggled by the user between a first state to cause said graphical user interface to highlight on the representation of the contents of the receptacle the location of each of the at least one prohibited object deemed to be depicted in the image, and a second state to cause said graphical user interface to not highlight on the representation of the contents of the receptacle the location of each of the at least one prohibited object deemed to be depicted in the image.

24. Apparatus as claimed in claim 22, wherein said graphical user interface is adapted to highlight on the representation of the contents of the receptacle the location of each of the at least one prohibited object deemed to be depicted in the image by displaying, for each of the at least one prohibited object deemed to be depicted in the image, a graphical indicator indicating the location of that prohibited object on the representation of the contents of the receptacle.

25. Apparatus as claimed in claim 23, wherein the receptacle is a currently screened receptacle, said apparatus comprising a storage component for storing history image data associated with images of contents of receptacles previously screened by said apparatus, said graphical user interface being adapted for displaying a representation of the contents of each of at least one of the receptacles previously screened by said apparatus on a basis of the history image data.

26. Apparatus as claimed in claim 25, wherein said graphical user interface is adapted for displaying concurrently a representation of the contents of each of plural ones of the receptacles previously screened by said apparatus on a basis of the history image data.

27. Apparatus as claimed in claim 25, wherein said graphical user interface is adapted for providing at least one control allowing a user to cause said graphical user interface to display the representation of the contents of each of at least one of the receptacles previously screened by said apparatus.

28. Apparatus as claimed in claim 26, wherein said graphical user interface is adapted for providing at least one control allowing a user to cause said graphical user interface to display concurrently the representation of the contents of each of plural ones of the receptacles previously screened by said apparatus.

29. Apparatus as claimed in claim 22, wherein said processing unit is adapted for processing the image data and data associated with a plurality of prohibited objects to be detected to determine whether the image depicts at least one of the prohibited objects.

30. Apparatus as claimed in claim 29, wherein the data associated with a plurality of prohibited objects to be detected comprises a plurality of data elements respectively associated with the prohibited objects to be detected, said processing comprising, for each particular one of the data elements, effecting a correlation operation between the image data and the particular one of the data elements.

31. A computer implemented graphical user interface for use in performing a security screening operation on receptacles to detect presence of one or more prohibited objects in the receptacles, said computer implemented graphical user interface comprising: a component for displaying a representation of contents of a receptacle, the representation of contents of a receptacle being derived from image data conveying an image of the contents of the receptacle, the image data being derived from a device that scans the receptacle with penetrating radiation; and a component for providing at least one control allowing a user to select whether or not said computer implemented graphical user interface highlights on the representation of the contents of the receptacle a location of each of at least one prohibited object deemed to be depicted in the image.

32. A method for performing a security screening operation on receptacles to detect presence of one or more prohibited objects in the receptacles, said method comprising:
receiving image data conveying an image of contents of a receptacle, the image data being derived from a device that scans the receptacle with penetrating radiation;
processing the image data to determine whether the image depicts at least one prohibited object; and
displaying on a graphical user interface a representation of the contents of the receptacle on a basis of the image data; and
providing on the graphical user interface at least one control allowing a user to select whether or not said graphical user interface highlights on the representation of the contents of the receptacle a location of each of at least one prohibited object deemed to be depicted in the image.

33. A method as claimed in claim 32, wherein the at least one control comprises a first control adapted to be toggled by the user between a first state to cause said graphical user interface to highlight on the representation of the contents of the receptacle the location of each of the at least one prohibited object deemed to be depicted in the image, and a second state to cause said graphical user interface to not highlight on the representation of the contents of the receptacle the location of each of the at least one prohibited object deemed to be depicted in the image.

34. A method as claimed in claim 32, wherein highlighting on the representation of the contents of the receptacle the location of each of the at least one prohibited object deemed to be depicted in the image comprises displaying, for each of the at least one prohibited object deemed to be depicted in the image, a graphical indicator indicating the location of that prohibited object on the representation of the contents of the receptacle.

35. A method as claimed in claim 33, wherein the receptacle is a currently screened receptacle, said method comprising:
storing history image data associated with images of contents of previously screened receptacles; and
displaying on the graphical user interface a representation of the contents of each of at least one of the previously screened receptacles on a basis of the history image data.

36. A method as claimed in claim 35, wherein displaying on the graphical user interface a representation of the contents of each of at least one of the previously screened receptacles comprises displaying concurrently a representation of the contents of each of plural ones of the previously screened receptacles.

37. A method as claimed in claim 35, comprising providing at least one control allowing a user to cause the graphical user interface to display the representation of the contents of each of at least one of the previously screened receptacles.

38. A method as claimed in claim 36, comprising providing at least one control allowing a user to cause the graphical user interface to display the representation of the contents of each of plural ones of the previously screened receptacles.

39. A method as claimed in claim 32, wherein said processing comprises processing the image data and data associated with a plurality of prohibited objects to be detected to determine whether the image depicts at least one of the prohibited objects.

40. A method as claimed in claim 39, wherein the data associated with a plurality of prohibited objects to be detected comprises a plurality of data elements respectively associated with the prohibited objects to be detected, said processing comprising, for each particular one of the data elements, effecting a correlation operation between the image data and the particular one of the data elements.

41. Apparatus for performing a security screening operation on receptacles to detect presence of one or more prohibited objects in the receptacles, said apparatus comprising:
an input for receiving image data conveying an image of contents of a receptacle, the image data being derived from a device that scans the receptacle with penetrating radiation;
a processing unit for:
processing the image data to detect depiction of one or more prohibited objects in the image; and
responsive to detection that the image depicts at least one prohibited object, deriving a level of confidence in the detection; and
a graphical user interface for displaying:
a representation of the contents of the receptacle derived from the image data; and
information conveying the level of confidence.

42. Apparatus as claimed in claim 41, wherein the information conveying the level of confidence conveys the level of confidence using a color scheme.

43. Apparatus as claimed in claim 42, wherein the color scheme includes at least three different colors representing different levels of confidence.

44. Apparatus as claimed in claim 41, wherein the information conveying the level of confidence conveys the level of confidence using a shape scheme.

45. Apparatus as claimed in claim 44, wherein the shape scheme includes at least three different shapes representing different levels of confidence.

46. Apparatus as claimed in claim 41, wherein the information conveying the level of confidence comprises a number.

47. Apparatus as claimed in claim 46, wherein the number is a percentage.

48. Apparatus as claimed in claim 41, wherein the receptacle is a currently screened receptacle, said apparatus comprising a storage component for storing history image data associated with images of contents of receptacles previously screened by said apparatus, said graphical user interface being adapted for displaying a representation of the contents of each of at least one of the receptacles previously screened by said apparatus on a basis of the history image data.

49. Apparatus as claimed in claim 48, wherein said graphical user interface is adapted for displaying concurrently a representation of the contents of each of plural ones of the receptacles previously screened by said apparatus on a basis of the history image data.

50. Apparatus as claimed in claim 48, wherein said graphical user interface is adapted for providing at least one control allowing a user to cause said graphical user interface to display the representation of the contents of each of at least one of the receptacles previously screened by said apparatus.

51. Apparatus as claimed in claim 49, wherein said graphical user interface is adapted for providing at least one control allowing a user to cause said graphical user interface to display concurrently the representation of the contents of each of plural ones of the receptacles previously screened by said apparatus.

52. Apparatus as claimed in claim 41, wherein said processing unit is adapted for processing the image data and data associated with a plurality of prohibited objects to be detected to detect depiction of at least one of the prohibited objects in the image.

53. Apparatus as claimed in claim 52, wherein the data associated with a plurality of prohibited objects to be detected comprises a plurality of data elements respectively associated with the prohibited objects to be detected, said processing comprising, for each particular one of the data elements, effecting a correlation operation between the image data and the particular one of the data elements.

54. Apparatus as claimed in claim 41, wherein said graphical user interface is adapted for, when said processing unit detects that the image depicts at least one prohibited object, highlighting a location of each of the at least one prohibited object on the representation of the contents of the receptacle.

55. Apparatus as claimed in claim 54, wherein said graphical user interface is adapted for highlighting the location of each of the at least one prohibited object on the representation of the contents of the receptacle by displaying, for each of the at least one prohibited object, a graphical indicator indicating the location of that prohibited object on the representation of the contents of the receptacle.

56. Apparatus as claimed in claim 41, wherein said graphical user interface is adapted for providing at least one control allowing a user to select whether or not said graphical user interface, when said processing unit detects that the image depicts at least one prohibited object, highlights a location of each of the at least one prohibited object on the representation of the contents of the receptacle.

57. Apparatus as claimed in claim 56, wherein said graphical user interface is adapted to highlight the location of each of the at least one prohibited object on the representation of the contents of the receptacle by displaying, for each of the at least one prohibited object, a graphical indicator indicating the location of that prohibited object on the representation of the contents of the receptacle.

58. A computer implemented graphical user interface for use in performing a security screening operation on receptacles to detect presence of one or more prohibited objects in the receptacles, said computer implemented graphical user interface comprising: a component for displaying a representation of contents of a receptacle, the representation of contents of a receptacle being derived from image data conveying an image of the contents of the receptacle, the image data being derived from a device that scans the receptacle with penetrating radiation; and a component for displaying information conveying a level of confidence in a detection that the image depicts at least one prohibited object, the detection being performed by a processing unit processing the image data.

59. A method for performing a security screening operation on receptacles to detect presence of one or more prohibited objects in the receptacles, said method comprising:
receiving image data conveying an image of contents of a receptacle, the image data being derived from a device that scans the receptacle with penetrating radiation;
processing the image data to detect depiction of one or more prohibited objects in the image;
responsive to detection that the image depicts at least one prohibited object, deriving a level of confidence in the detection;
displaying on a graphical user interface a representation of the contents of the receptacle derived from the image data; and
displaying on the graphical user interface information conveying the level of confidence.

60. A method as claimed in claim 59, wherein the information conveying the level of confidence conveys the level of confidence using a color scheme.

61. A method as claimed in claim 60, wherein the color scheme includes at least three different colors representing different levels of confidence.

62. A method as claimed in claim 59, wherein the information conveying the level of confidence conveys the level of confidence using a shape scheme.

63. A method as claimed in claim 62, wherein the shape scheme includes at least three different shapes representing different levels of confidence.

64. A method as claimed in claim 59, wherein the information conveying the level of confidence comprises a number.

65. A method as claimed in claim 64, wherein the number is a percentage.

66. A method as claimed in claim 59, wherein the receptacle is a currently screened receptacle, said method comprising:
storing history image data associated with images of contents of previously screened receptacles; and
displaying on the graphical user interface a representation of the contents of each of at least one of the previously screened receptacles on a basis of the history image data.

67. A method as claimed in claim 66, wherein said displaying on the graphical user interface a representation of the contents of each of at least one of the previously screened receptacles comprises displaying concurrently on the graphical user interface a representation of the contents of each of plural ones of the previously screened receptacles on a basis of the history image data.

68. A method as claimed in claim 66, comprising providing on the graphical user interface at least one control allowing a user to cause the graphical user interface to display the representation of the contents of each of at least one of the previously screened receptacles.

69. A method as claimed in claim 67, comprising providing on the graphical user interface at least one control allowing a user to cause the graphical user interface to display concurrently the representation of the contents of each of plural ones of the previously screened receptacles.

70. A method as claimed in claim 59, wherein said processing comprises processing the image data and data associated with a plurality of prohibited objects to be detected to detect depiction of at least one of the prohibited objects in the image.

71. A method as claimed in claim 70, wherein the data associated with a plurality of prohibited objects to be detected comprises a plurality of data elements respectively associated with the prohibited objects to be detected, said processing comprising, for each particular one of the data elements, effecting a correlation operation between the image data and the particular one of the data elements.

72. A method as claimed in claim 59, comprising, upon detecting that the image depicts at least one prohibited object, highlighting a location of each of the at least one prohibited object on the representation of the contents of the receptacle.

73. A method as claimed in claim 72, wherein said highlighting comprises displaying, for each of the at least one prohibited object, a graphical indicator indicating the location of that prohibited object on the representation of the contents of the receptacle.

74. A method as claimed in claim 59, comprising providing on the graphical user interface at least one control allowing a user to select whether or not the graphical user interface, upon detecting that the image depicts at least one prohibited object, highlights a location of each of the at least one prohibited object on the representation of the contents of the receptacle.

75. A method as claimed in claim 74, wherein highlighting the location of each of the at least one prohibited object on the representation of the contents of the receptacle comprises displaying, for each of the at least one prohibited object, a graphical indicator indicating the location of that prohibited object on the representation of the contents of the receptacle.
